(19) United States
(12) Patent Application Publication
(10) Pub. No.: US 2020/0394638 A1
(43) Pub. Date: Dec. 17, 2020

(54) Method of Managing a Personal Payment Platform

(71) Applicants: Martin Thomas Mcleod, San Rafael, CA (US); Christopher M. Hughes, San Rafael, CA (US)

(72) Inventors: Martin Thomas Mcleod, San Rafael, CA (US); Christopher M. Hughes, San Rafael, CA (US)

(21) Appl. No.: 16/902,258

(22) Filed: Jun. 15, 2020

Related U.S. Application Data
(60) Provisional application No. 62/861,912, filed on Jun. 14, 2019.

(51) Int. Cl. G06Q 20/22; G06Q 20/34; G06Q 20/38; G06Q 20/36; G06Q 20/40; G06Q 30/02; G06Q 10/02; G06Q 10/08

(52) U.S. Cl. CPC G06Q 20/227; G06Q 20/351; G06Q 20/389; G06Q 20/3674; G06Q 10/087; G06Q 30/0261; G06Q 30/0255; G06Q 10/02; G06Q 20/40145

(57) ABSTRACT

A method of managing a personal payment platform details a system wherein users are provided with a single electronic card that serves as a card compiler for a user's various credit and debit cards. A remote server connects the various cards to the single electronic card and determines, based on the user's purchase history, card deals or discounts, sales, limits, user preferences, and other relevant information, which card is most appropriate to use for a given purchase. An application allows the user to pay through their phone, thus allowing the user to exit the store without approaching a cash register. Server information may be utilized by stores to offer relevant promotions, to manage inventory, and more. A platform improves communication between users and business entities by automating different services; for example, allowing a user to register a new credit card without communicating directly with the bank or credit card company.

The current application claims a priority to the U.S. Provisional Patent application Ser. No. 62/861,912 filed on Jun. 14, 2019. The current application is filed on Jun. 15, 2020 while Jun. 14, 2020 was on a weekend.

### FIELD OF THE INVENTION

The present invention relates generally to a transaction platform. More specifically, a method of managing a personal payment platform relates to a platform that allows users (individuals, stores, professional services, shopping malls, gas stations, and many others) to connect and access a wide variety of communication and financial management benefits, making it the ultimate hub for customer engagement.

### BACKGROUND OF THE INVENTION

Financial management has never been more complex than today. Individuals have to manage multiple accounts, allowing for income collection and accounting for interest for even the most basic checking and savings accounts. They are then responsible for storing, monitoring, and regulating activity on a wide array of multi-purpose credit and debit cards. Such monitoring extends to include calculating taxes and tracking a credit score. Even experts could struggle to make appropriate decisions with respect to which cards to use and how much one can spend, let alone an untrained individual. Such concerns are certainly no easier on the commercial side. Businesses require highly accurate accounting to minimize theft at retail locations, or to prevent issues from a tax audit. These decisions must be made using a vast amount of data and must be analyzed automatically by appropriately-equipped machines. What is needed is a device that can automate the financial decision-making process for both individuals and businesses. Further desirable is a system for facilitating appropriate interactions between clients, or between clients and business services.

The present invention addresses these issues. A method of managing a personal payment platform details a system wherein users are provided with a single electronic card that serves as a card compiler for a user's various credit and debit cards. A remote server connects the various cards to the single electronic card and uses machine learning and artificial intelligence to determine, based on the user's purchase history, card deals or discounts, sales, limits, user preferences, and other such relevant information, which card is most appropriate to use for a given purchase. An application allows the user to pay through their phone, thus allowing the user to exit the store without approaching a cash register. Server information may be utilized by stores to offer relevant promotions, to manage inventory, and for a variety of other purposes. The present invention further provides a platform that improves communication between users and business entities by automating different services; for example, allowing a user to register a new credit card without communicating directly with the bank or credit card company.

### BRIEF DESCRIPTION OF THE DRAWINGS

FIG. 1 is a block diagram illustrating the system of the present invention.

FIG. 2 is a flowchart illustrating an overall process for the method of the present invention.

FIG. 3 is a flowchart illustrating the subprocess of scanning in credit cards.

FIG. 4 is a flowchart illustrating the subprocess of replacing a physical access card.

FIG. 5 is a flowchart illustrating the subprocess of touching phones to exchange funds.

FIG. 6 is a flowchart illustrating the subprocess of holding payment in a virtual vault.

FIG. 7 is a flowchart illustrating the subprocess of notifying appropriate authorities of travel plans.

FIG. 8 is a flowchart illustrating the subprocess of activating a new virtual credit card.

FIG. 9 is a flowchart illustrating the subprocess of freezing a credit card.

FIG. 10 is a flowchart illustrating the subprocess of compiling a transaction statement.

FIG. 11 is a flowchart illustrating the subprocess of providing financial services.

FIG. 12 is a flowchart illustrating the subprocess of providing travel services.

FIG. 13 is a flowchart illustrating the subprocess of tracking the location of a physical access card.

FIG. 14 is a flowchart illustrating the subprocess of transferring money with a personal bank account.

FIG. 15 is a flowchart illustrating the subprocess of temporarily freezing all virtual credit cards.

FIG. 16 is a flowchart illustrating the subprocess of linking to a widget.

FIG. 17 is a flowchart illustrating the subprocess of providing biometric authentication.

FIG. 18 is a flowchart illustrating the subprocess of receiving payments through an aisle hub.

FIG. 19 is a flowchart illustrating the subprocess of advertising through geofenced stores.

FIG. 20 is a flowchart illustrating the subprocess of scanning to pay for an item.

FIG. 21 is a flowchart illustrating the subprocess of advertising based on purchase history.

FIG. 22 is a flowchart illustrating the subprocess of managing service requests.

FIG. 23 is a flowchart illustrating the subprocess of displaying lower prices on shopping list items.

FIG. 24 is a flowchart illustrating the subprocess of advertising frequently purchased items on the shopping list.

FIG. 25 is a flowchart illustrating the subprocess of managing items on a shopping list.

FIG. 26 is a flowchart illustrating the subprocess of providing vehicle maintenance warnings.

FIG. 27 is a flowchart illustrating the subprocess of managing and renewing memberships.

FIG. 28 is a flowchart illustrating the subprocess of purchasing event tickets.

### DETAILED DESCRIPTION OF THE INVENTION

All illustrations of the drawings are for the purpose of describing selected versions of the present invention and are not intended to limit the scope of the present invention.

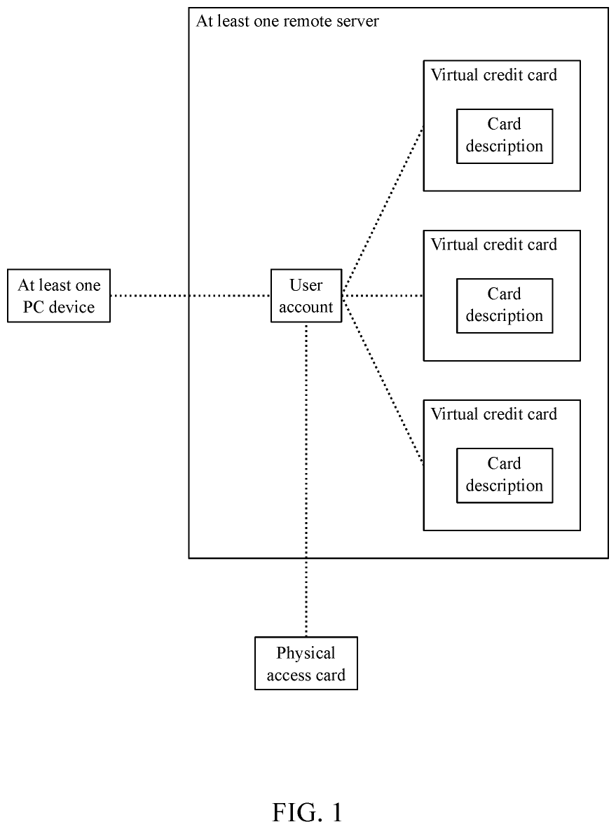

The present invention is a method of managing a personal payment platform that allows users, including individuals and business entities, to connect and access a wide variety of communication and financial management benefits. The present invention accomplishes this by providing an application that connects to a remote server or series of remote servers capable of managing payments, accounts, and automating a variety of tedious financial tasks, as shown in FIG. 1. The system of the present invention includes at least one user account managed on at least one remote server, wherein the user account is associated with at least one user personal computing (PC) device, and wherein the user account is associated with a plurality of virtual credit cards managed by the remote server, and wherein each virtual credit card includes a card description, and wherein the user account is associated with a physical access card (Step A). The at least one user account relates to a profile and related services associated with an individual. The at least one remote server relates to a series of servers, databases, and other information technology required to connect to the at least one user PC device, collect relevant data, apply preprogrammed logic, and relay appropriate responses to appropriate recipients. The at least one user PC device is any of a variety of computers, smartphones, laptops, or other devices capable of supporting the application of the present invention and connecting to the internet. The plurality of virtual credit cards relates to the set of credit cards owned and utilized by the user account. The card description is the set of metrics relevant to determining optimal use, including, but not limited to, the card issuing company, number, expiration date, limit, balance, benefits, and more. The physical access card is a rigid item similar in shape and appearance to a variety of conventional credit cards that includes a magnetic strip, an insertable chip, and radio frequency identification (RFID) technology that enables the user to access the user's credit card accounts.

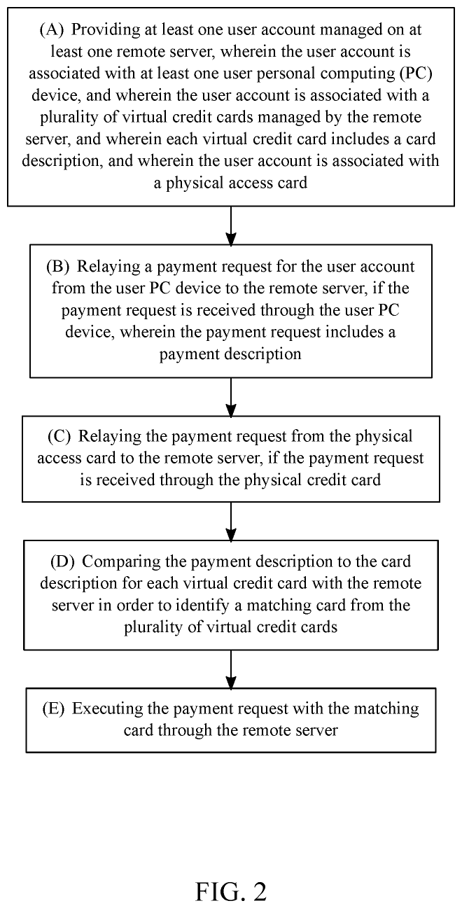

This arrangement of features enables the user to ensure all payments are made using the most appropriate card. Next, a payment request for the user account is relayed from the user PC device to the remote server, if the payment request is received through the user PC device, wherein the payment request includes a payment description, as represented in FIG. 2 (Step B). The payment request relates to an input generated when the user attempts to make a purchase, either remotely or in person. The payment description includes information including, but not limited to, item name, item identifying information and codes, price, store name, store location, tax information, shipping and handling information, discount codes, and more. The payment request is next relayed from the physical access card to the remote server, if the payment request is received through the physical credit card (Step C). This arrangement allows the user to confirm any purchase before being charged for the purchase. The payment description is then compared to the card description for each virtual credit card with the remote server in order to identify a matching card from the plurality of virtual credit cards (Step D).

The remote server may employ a variety of data analysis techniques, including machine learning algorithms, artificial intelligence modules, statistical deduction, or other such tools in order to determine the best card for the user to use to fill the payment request. Finally, the payment request is executed with the matching card through the remote server (Step E). This completes the transaction by charging the appropriate card the appropriate amount for the requested item or service.

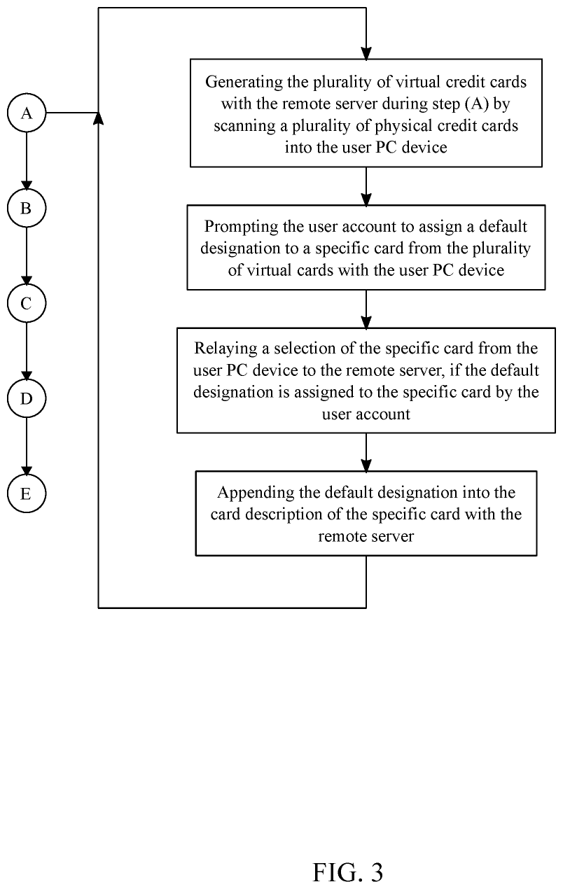

The user may desire to place a particular emphasis on a specific card manually, thus overriding any artificial intelligence recommendations. To achieve this, first, the plurality of virtual credit cards is generated with the remote server during Step A by scanning a plurality of physical credit cards into the user PC device, as represented in FIG. 3. This arrangement allows the user to declare and store credit card information for subsequent use and access by the remote server. Next, the user account is prompted to assign a default designation to a specific card from the plurality of virtual cards with the user PC device. The default designation substantially increases the desirability score of the specific card relative to the plurality of virtual cards, ensuring that the specific card is utilized more often. A selection of the specific card is next relayed from the user PC device to the remote server, if the default designation is assigned to the specific card by the user account. This arrangement allows the remote server to apply user preferences to the plurality of virtual cards during the process of deciding which card to apply for a given purchase. Finally, the default designation is appended into the card description of the specific card with the remote server. In this way, the specific card is identified as the most desirable card for most purchases, therefore preferred in the event of a tiebreaker between different cards.

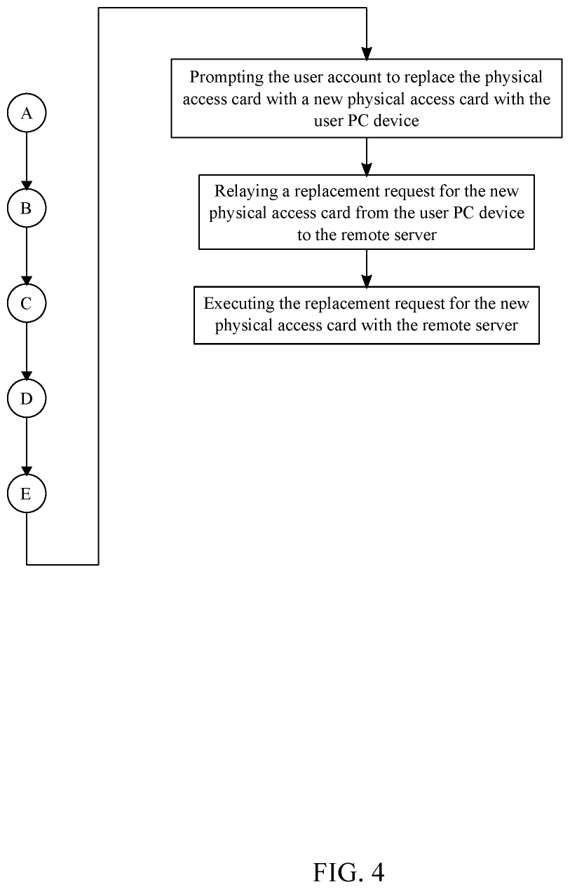

It is often advantageous for the user to swap an older physical access card for a newer physical access card in order to address any security issues, such as concerns over a lost or stolen card. To address these concerns, the user account is prompted to replace the physical access card with a new physical access card with the user PC device, as represented in FIG. 4. The new physical access card is similar to the physical access card, but with upgraded component specifications according to what upgraded card components are available at the time. A replacement request for the new physical access card is relayed from the user PC device to the remote server. The replacement request may include a series of identification steps in order to verify the identity of the user. Next, the replacement request for the new physical access card is executed with the remote server. Thus, the user obtains a new physical access card that is connected to the plurality of virtual cards.

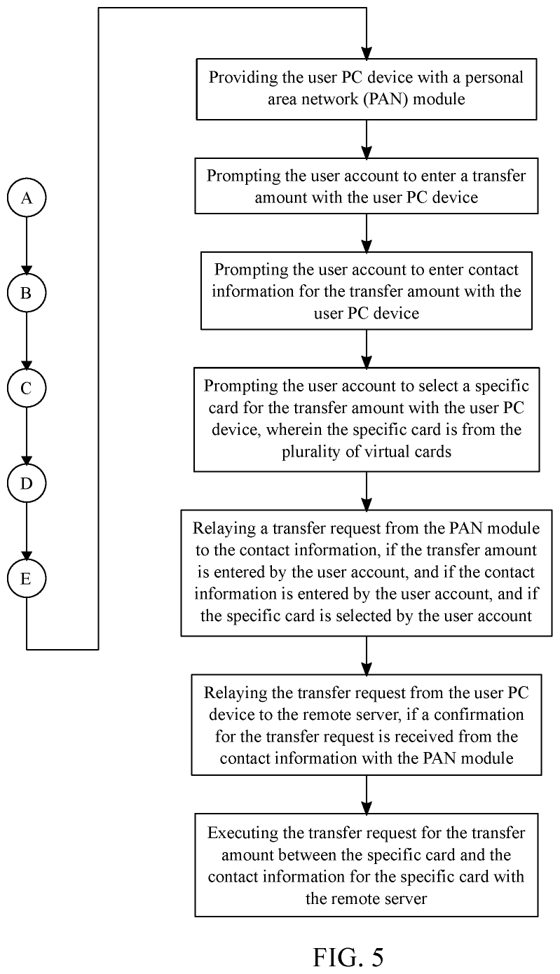

Multiple users may desire secure and convenient financial transfers between connected devices. To achieve this, the user PC device is provided with a personal area network (PAN) module, as represented in FIG. 5. The PAN module relates to a device capable of securing a short-range wireless connection between appropriately-equipped user PC devices. The user account is prompted to enter a transfer amount with the user PC device. The transfer amount is a numerical value representing an amount of currency that the user PC device wishes to transfer. The user account is next prompted to enter contact information for the transfer amount with the user PC device. The contact information is a set of identifying and locating information that potentially includes, but is not limited to, name, internet protocol (IP) address, location information, phone number, email address, and more. The user account is then prompted to select a specific card for the transfer amount with the user PC device, wherein the specific card is from the plurality of virtual cards. In this way, the user account controls the flow of money out of a desirable account. This process may also in some embodiments be automated through machine learning or artificial intelligence, thus streamlining the process. Next, a transfer request is relayed from the PAN module to the contact information, if the transfer amount is entered by the user account, and if the contact information is entered by the user account, and if the specific card is selected by the user account. The connection is made directly between the two devices, thus enhancing security by shortening the protocol diagram and reducing potential areas for a hostile entity to interrupt the transaction. The transfer request is then relayed from the user PC device to the remote server, if a confirmation for the transfer request is received from the contact information with the PAN module. In this way, transactions are monitored and recorded for reference and subsequent analysis, thus preventing unauthorized transactions. Finally, the transfer request for the transfer amount is executed between the specific card and the contact information for the specific card with the remote server. This completes the transaction between the user account and the recipient.

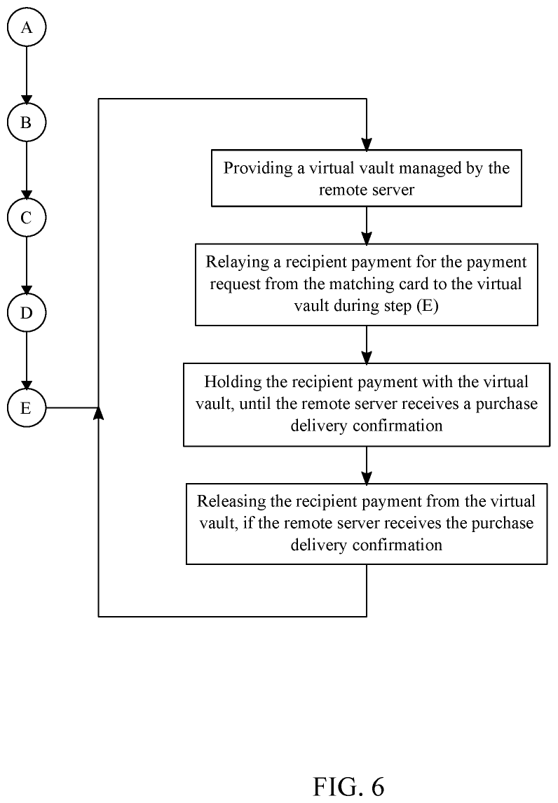

All transactions require verification at multiple points to ensure security and user permission. To further improve the security of each transaction, a virtual vault managed by the remote server is provided, as represented in FIG. 6. The virtual vault relates to a temporary money storage space that allows for the remote server to confirm the existence of the money and queuing of a transaction. A recipient payment for the payment request is relayed from the matching card to the virtual vault during Step E. The recipient payment relates to the amount of money to be transferred during a transaction. The recipient payment is then held with the virtual vault, until the remote server receives a purchase delivery confirmation. This arrangement allows the virtual vault to ensure that the payment value is correct, and to authenticate the security of the connection before initiating a transaction. Finally, the recipient payment is released from the virtual vault, if the remote server receives the purchase delivery confirmation. Thus, the transaction is completed with increased security that does not interfere with the experience of the user account making a purchase.

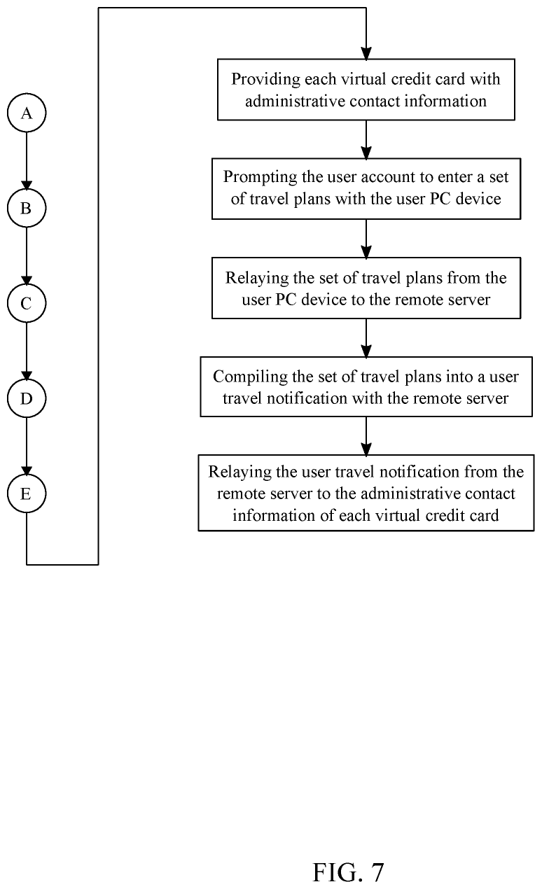

Often, credit card users experience difficulty when travelling to foreign countries, as they need to inform their banks and failure to do so often results in the card becoming frozen or restricted. To prevent this from occurring, each virtual credit card is provided with administrative contact information, as represented in FIG. 7. The administrative contact information relates to information regarding relevant phone numbers, email accounts, and other such common communication tools associated with a bank or financial institution. The user account is prompted to enter a set of travel plans with the user PC device. The set of travel plans may include, but is not limited to, information about the location, duration, accommodations, and more related to their travel itinerary. Once entered, the set of travel plans is relayed from the user PC device to the remote server. The remote server may then store and analyze relevant information as necessary. The set of travel plans is next compiled into a user travel notification with the remote server. The travel notification includes all of the relevant information required by the relevant travel institution. Finally, the user travel notification is relayed from the remote server to the administrative contact information of each virtual credit card. Thus, the administrative contact information receives the travel information necessary to prevent credit cards from locking down and becoming unusable during travel.

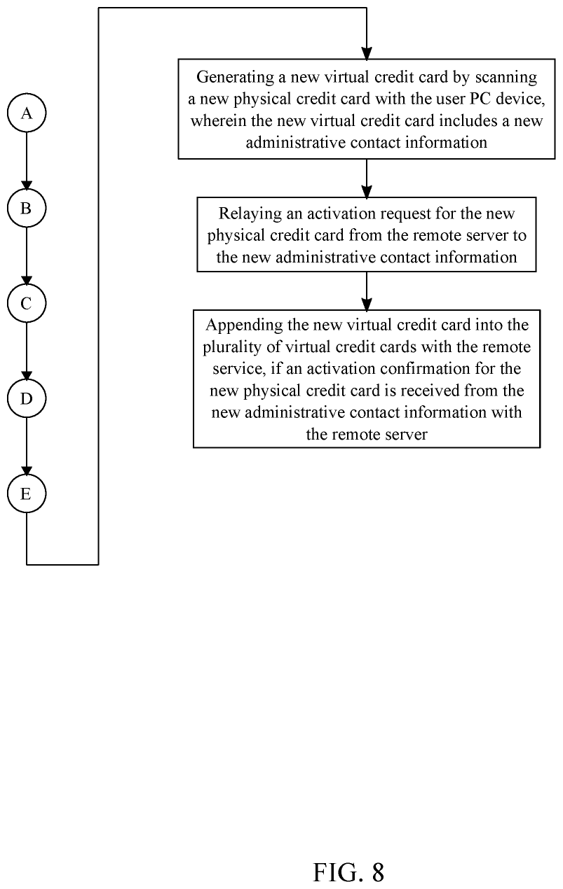

The user account may wish to utilize a new credit card for use with the physical access card. To enable this, a new virtual credit card is generated by scanning a new physical credit card with the user PC device, wherein the new virtual credit card includes a new administrative contact information, as represented in FIG. 8. In this way, the user may input all information required to register and utilize the new credit card with the physical access card. An activation request for the new physical credit card is then relayed from the remote server to the new administrative contact information. This arrangement ensures that the relevant financial institution receives information necessary to allow the virtual credit card to be used with the physical access card. Next, the new virtual credit card is appended into the plurality of virtual credit cards with the remote service, if an activation confirmation for the new physical credit card is received from the new administrative contact information with the remote server. The activation confirmation is a confirmed approval of the addition of the new physical credit card into the plurality of virtual credit cards received by the administrative contact information. Thus, new physical credit cards may be added into the plurality of virtual credit cards.

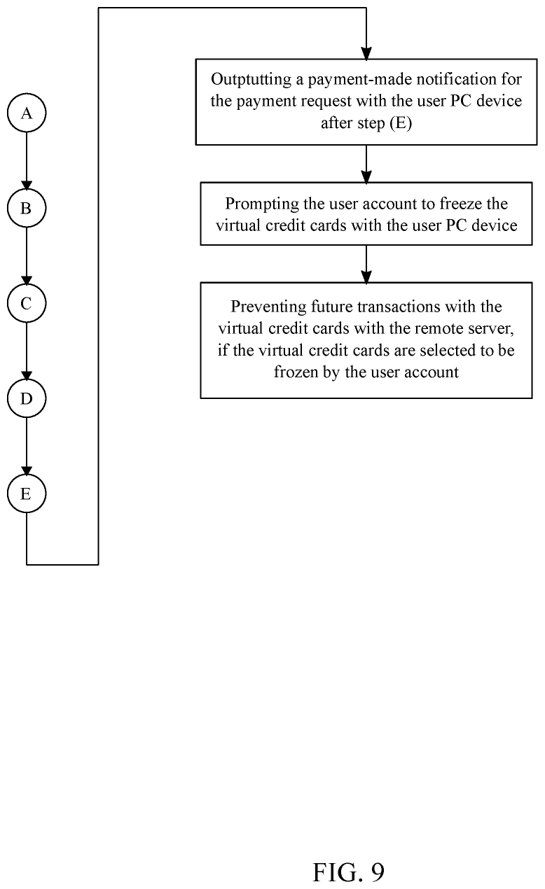

In the event of a security breach, the user must be able to interact with the plurality of virtual credit cards safely in order to prevent further unauthorized usage. To enable this, a payment-made notification for the payment request is outputted with the user PC device after Step E, as represented in FIG. 9. The payment made notification is a confirmation of a successful payment that may be utilized as a supplement, or in some cases, a replacement, for a receipt. Next, the user account is prompted to freeze the virtual credit cards with the user PC device. The user account may review all purchases in this way and thus be able to respond to unauthorized or unexpected purchases appropriately. Finally, future transactions with the virtual credit cards are prevented with the remote server, if the virtual credit cards are selected to be frozen by the user account. Thus, hostile entities may not abuse spending ability from captured information about the physical access card or connected virtual credit card accounts.

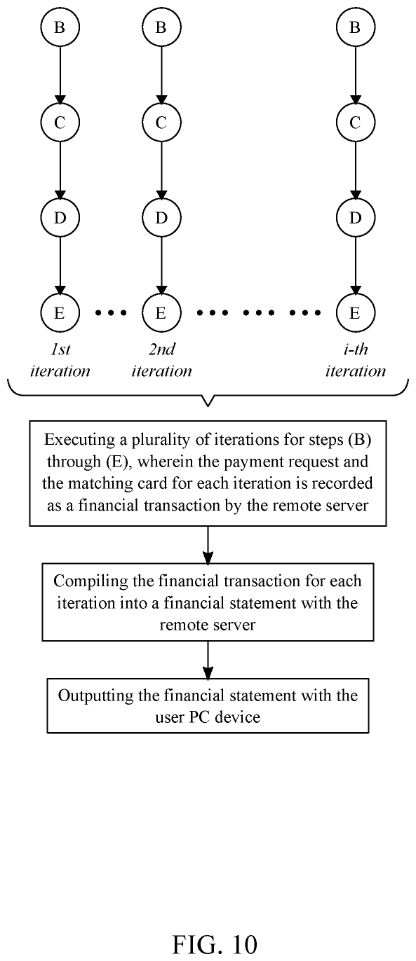

Many banks and financial institutions release documents relating to the spending habits of their users, including combined and arranged information about purchases in general. To provide a similar service, a plurality of iterations for Steps B through E are executed, wherein the payment request and the matching card for each iteration is recorded as a financial transaction by the remote server, as represented in FIG. 10. The financial transactions may be encrypted or hashed before recording, in order to further obfuscate confidential data from hostile entities. The financial transaction for each iteration is compiled into a financial statement with the remote server. The financial statement includes detailed information about each transaction, including cost, date, location of purchase, shipping and handling information, and any other metrics that may prove beneficial for the owner to have. Finally, the financial statement is outputted with the user PC device. The financial statement may be displayed in a variety of different ways and contained data may be presented in informative graphs and charts to assist user comprehension.

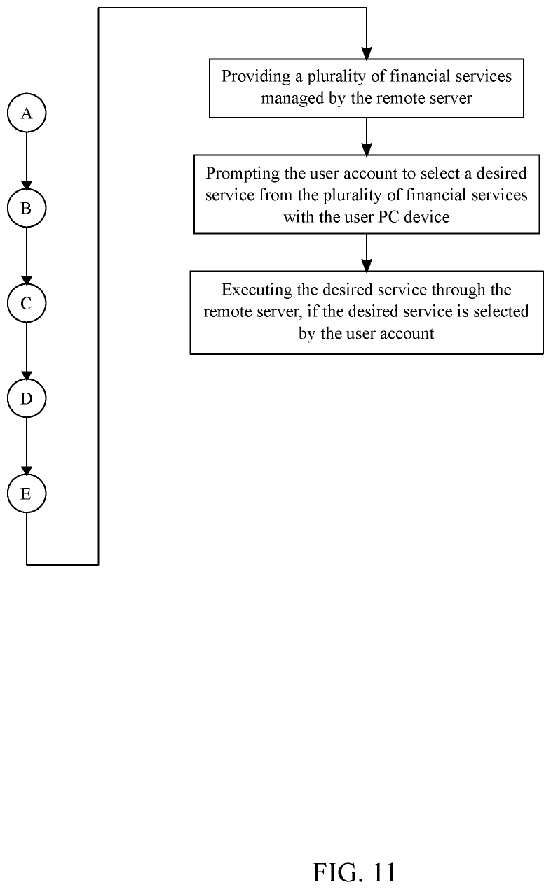

There are many other services that require the use of electronic payment today. To enable the user to more conveniently access these payments, a plurality of financial services managed by the remote server is provided, as represented in FIG. 11. The plurality of financial services may relate to any of a variety of services with which the user account may desire to utilize the physical access card. The user account is prompted to select a desired service from the plurality of financial services with the user PC device. The desired service may include items within categories, such as investments, recurring payments, financial advice, tax advice, savings, and more. Finally, the desired service is executed through the remote server, if the desired service is selected by the user account. Thus, the remote server is equipped to manage and display relevant information as necessary to the user account.

The plurality of financial services could refer to any financial transaction, including payments for items and services. In particular, the plurality of financial services includes a bookkeeping service, a tax calculation service, a business accounting service, a business travel-tracker service, a service for detecting fraudulent out-of-state transactions, an automated bill-paying service, a check depositing service, an automated savings service, a fraudulent-transactions management service, a fraudulent-transactions resolution service, a service for interacting with an automated teller machine, a service for managing/sharing discounts and promotions, a service for distributing virtual business cards, and more. Use of these services is facilitated through utilization of the application associated with the physical access card, automating the otherwise tedious and frustrating processes of dealing with phone calls, emails, coordinating financial and personal information and dates, and more.

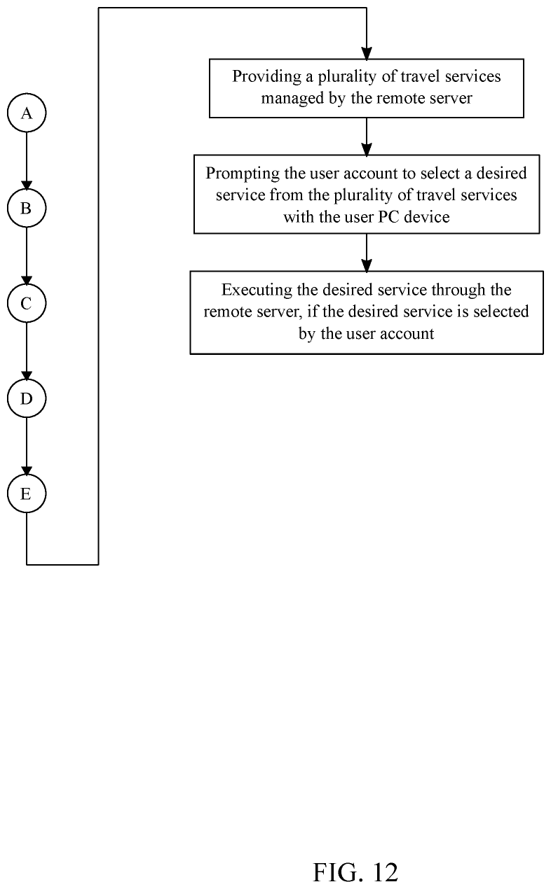

The present invention is also equipped to manage a series of travel tools, interacting with banks and lenders to ensure that there are not restrictions, limits, or problems in general while a user travels and to provide the user account with access to deals and discounts provided by various institutions. To enable such interactions, a plurality of travel services managed by the remote server is provided, as represented in FIG. 12. The plurality of travel services relates to a set of packages and deals accessible to users of different virtual credit cards. The user account is prompted to select a desired service from the plurality of travel services with the user PC device. Thus, the user may sort through different deals and pick appropriate ones for purchasing. Finally, the desired service is executed through the remote server, if the desired service is selected by the user account. This arrangement ensures that the appropriate service is performed with ease of use for the user account as the primary goal.

There are many travel packages, benefits, and other financial involvements associated with travel which the application associated with the physical access card may present to the user account. Among these, the plurality of travel services includes a vacation purchasing service, a hotel booking service, a transportation hiring service, and a virtual passport storage service. Each service here, and many more, provide the user account with access to money-saving tools and discounts that incentivize the user account to make a travel purchase.

Modern technologies utilize a variety of mechanisms to effectively communicate information from a credit card to a register or other device. To enable such communication, the physical access card is inscribed with a unique printed identifier, wherein the unique printed identifier is encoded with contact information for the user account. The unique printed identifier relates to any of barcodes, quick response (QR) codes, or other such scannable codes capable of connecting the application of the present invention to a purchase or purchase-registering device.

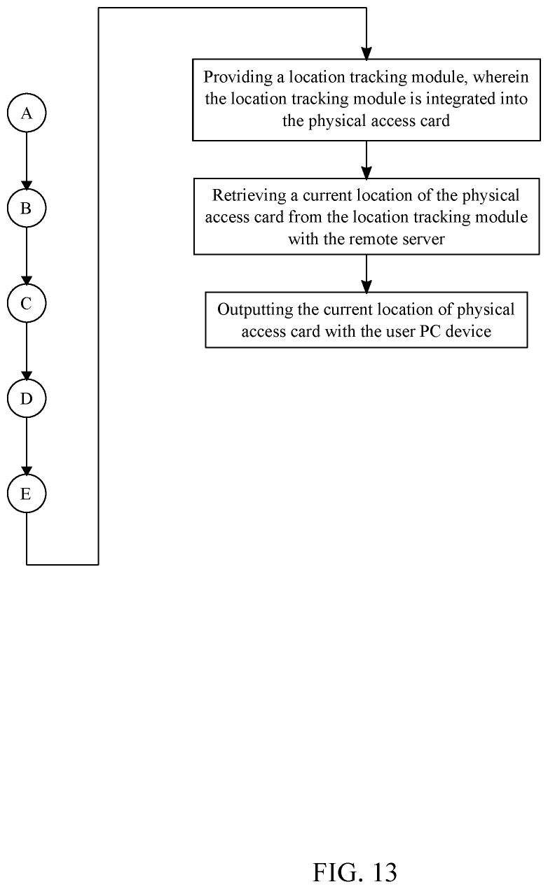

It is often advantageous to collect data related to the user of a credit card in order to enable location of the physical access card if the physical access card should become lost or stolen and also allows for processing and prediction of payments and shopping habits. To this end, a location tracking module is provided, wherein the location tracking module is integrated into the physical access card, as represented in FIG. 13. The location tracking module may be a global positioning system (GPS), or a variety of other systems capable of finding the general location of the physical access card. A current location of the physical access card is retrieved from the location tracking module with the remote server. This allows for subsequent display of the current location, as well as processing of the current location in relation to spending habits, thus allowing the present invention to associate certain purchases with specific business establishments. Finally, the current location of physical access card is outputted with the user PC device. In this way, the user account is provided with the information required for the user to locate the physical access card.

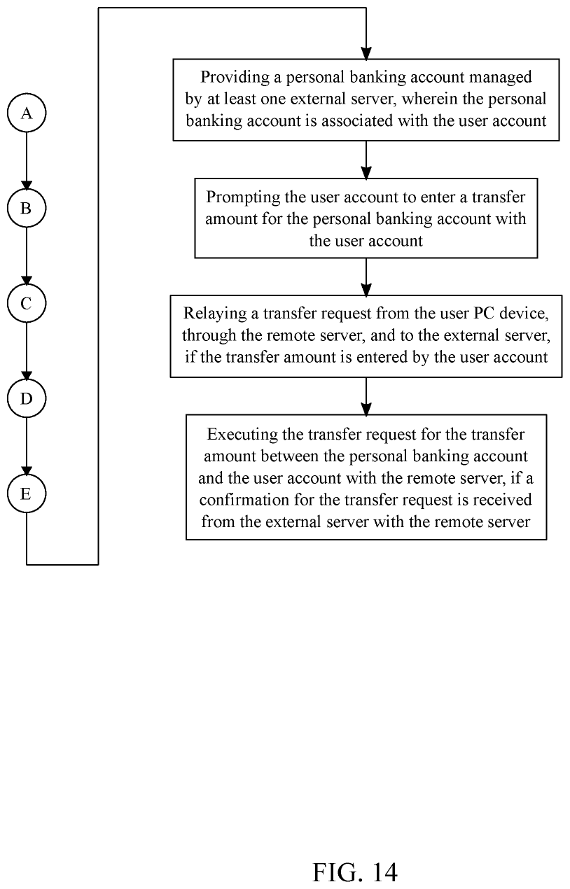

The user of the present invention may wish to make cash withdrawals from an automated teller machine (ATM). To enable this, a personal banking account managed by at least one external server is provided, wherein the personal banking account is associated with the user account, as represented in FIG. 14. The personal banking account may be associated with one of the plurality of virtual credit cards or a separate debit card. The user account is next prompted to enter a transfer amount for the personal banking account with the user account. The transfer amount relates to the value of cash the user account wishes to access. A transfer request is then relayed from the user PC device, through the remote server, and to the external server, if the transfer amount is entered by the user account. In this way, transfer requests may be processed, recorded, analyzed, and authenticated before proceeding further. Then, the transfer request for the transfer amount is executed between the personal banking account and the user account with the remote server, if a confirmation for the transfer request is received from the external server with the remote server. Thus, the user account receives the cash value requested through the transfer amount.

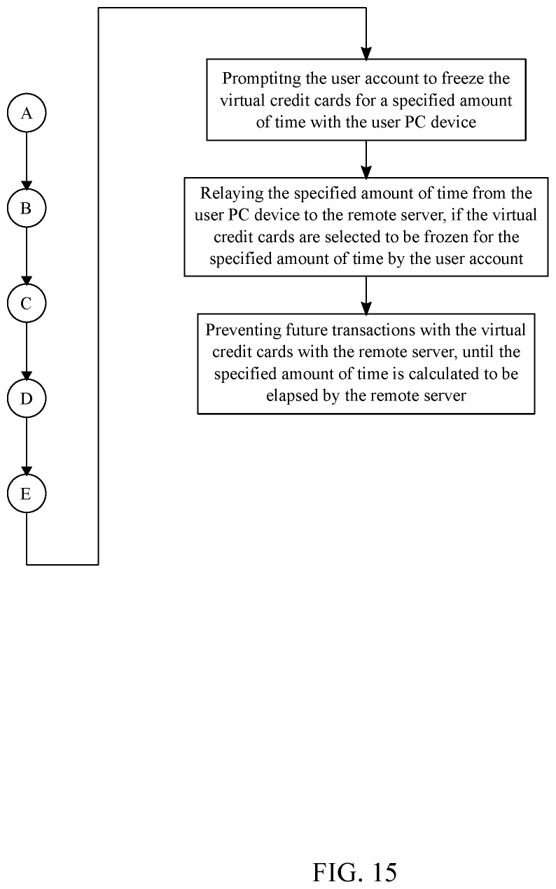

Many transactions by thieves or hostile parties occur after the user makes a purchase, making the time period following an in-person purchase a period of particular security vulnerability. To accommodate for this, the user account is prompted to freeze the virtual credit cards for a specified amount of time with the user PC device, as represented in FIG. 15. A planned account freeze prevents activity on the associated account or virtual credit card during that period. The specified amount of time is then relayed from the user PC device to the remote server, if the virtual credit cards are selected to be frozen for the specified amount of time by the user account. In this way, the remote server is provided with information necessary to restrict payments from being charged onto different virtual credit cards. Future transactions are then prevented with the virtual credit cards with the remote server, until the specified amount of time is calculated to be elapsed by the remote server. This arrangement prevents usage of cards during the specified amount of time, thus reducing the chances of unauthorized physical access card usage.

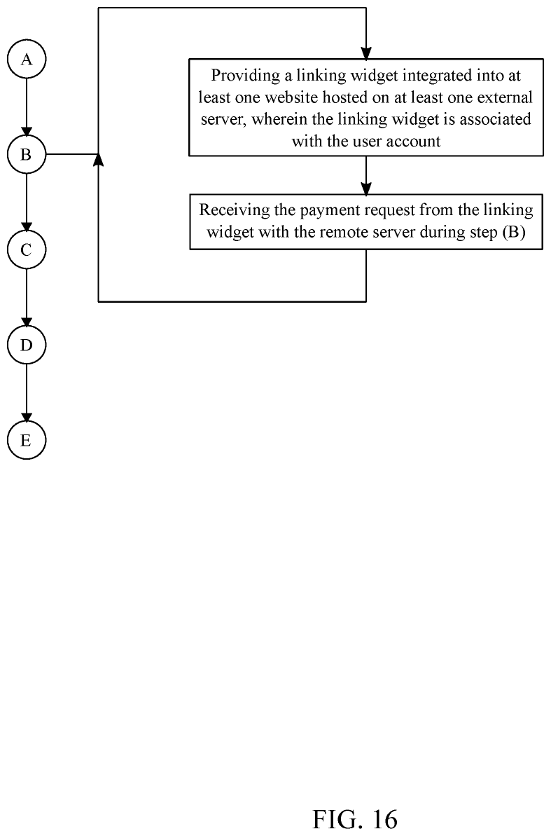

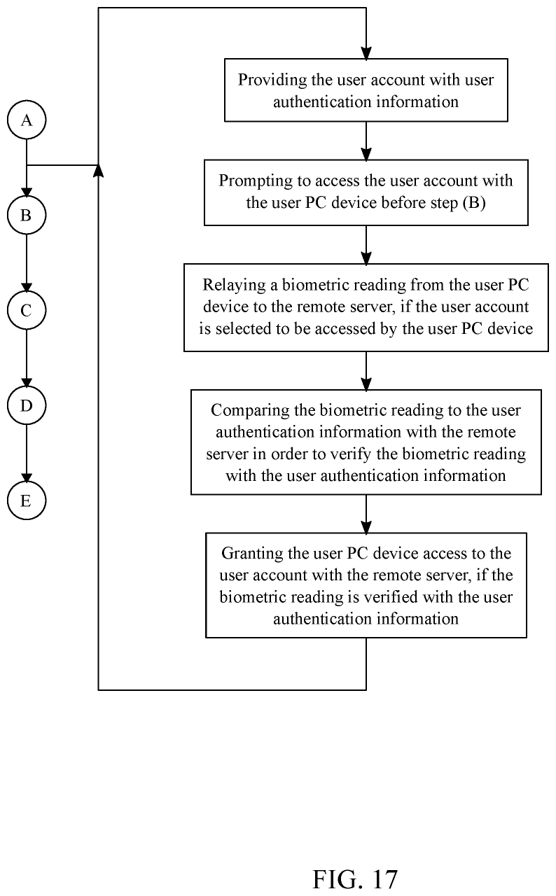

The user may wish to access the plurality of virtual credit cards and the associated artificial intelligence patterns in order to make purchases using the appropriate virtual credit card. To achieve this, a provided linking widget is integrated into at least one website hosted on at least one external server, wherein the linking widget is associated with the user account, as represented in FIG. 16. The linking widget may be presented with a logo or other identifying visual information that informs the user account of the widget's association with the plurality of virtual credit cards. The payment request is then received from the linking widget with the remote server during Step B. This arrangement ensures that the user may access the plurality of virtual credit cards conveniently from a variety of different external websites associated with the at least one external server. The present invention handles a compilation of very secure and confidential information for each user account and therefore must be equipped to uphold the highest standards of security. To achieve this, the user account is provided with user authentication information, as represented in FIG. 17. The authentication information may range from hashed and salted passwords, biometrics, security questions, and more. The user account is prompted to access the user PC device before Step B. Upon attempting to enter the user PC device, the user already begins the authentication process. A biometric reading is relayed from the user PC device to the remote server, if the user account is selected to be accessed by the user PC device. The biometric reading may include, but is not limited to, fingerprint scanning, iris scanning, facial recognition technology, or more. The biometric reading is then compared to the user authentication information with the remote server in order to verify the biometric reading with the user authentication information. This process enables secure verification of the identity of the user PC device. Subsequently, the user PC device is granted access to the user account with the remote server, if the biometric reading is verified with the user authentication information. Thus, the user account is only made accessible to the user of the present invention.

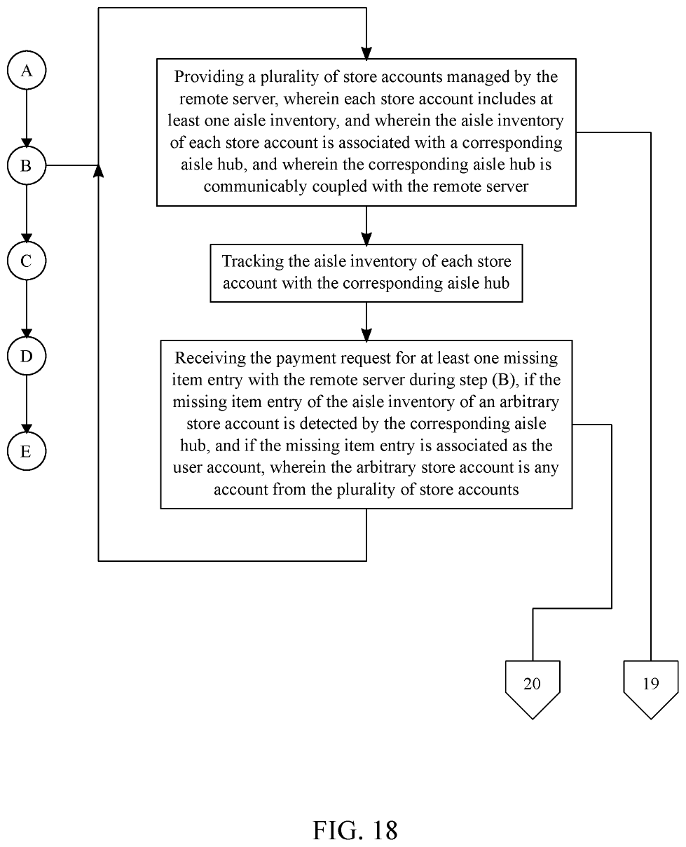

Modern shopping and retail environments may be optimized by addressing the need for cash registers and cashiers to work them. To address this area, a plurality of store accounts managed by the remote server is provided, wherein each store account includes at least one aisle inventory, and wherein the aisle inventory of each store account is associated with a corresponding aisle hub, and wherein the corresponding aisle hub is communicably coupled with the remote server, as represented in FIG. 18. The plurality of store accounts relates to a profile or collection of profiles associated with the management and operation of a retail store. The at least one aisle inventory relates to the number of items of a particular variety that are in stock at a given time. The corresponding aisle hub relates to a device which monitors the shelf stock of each item within that aisle. The aisle inventory of each store account is tracked with the corresponding aisle hub. In this way, the corresponding aisle hub is provided with information about the price, location, and presence of each item in the store. The payment request for at least one missing item entry is received with the remote server during Step B, if the missing item entry of the aisle inventory of an arbitrary store account is detected by the corresponding aisle hub, and if the missing item entry is associated as the user account, wherein the arbitrary store account is any account from the plurality of store accounts. Thus, the remote server connects each user account with the appropriate missing items, enabling each user account to be billed appropriately for the items they purchase without having to approach a cash register.

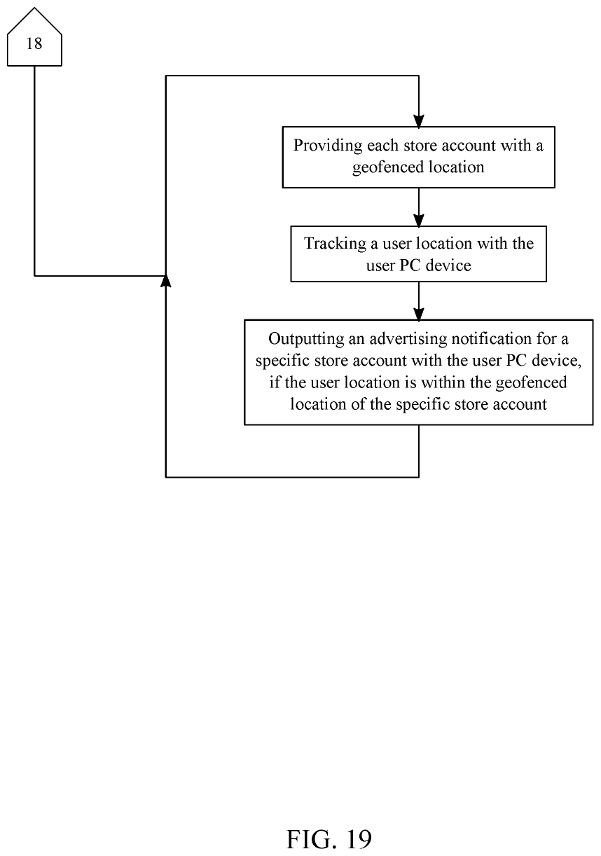

The application of the present invention enables the user to benefit from recommendations based on previous purchases and shopping lists. To provide for this feature, each store account is provided with a geofenced location, as represented in FIG. 19. The geofenced location relates to a boundary around a certain radius of the retail location. A user location is tracked with the user PC device. The user location may be tracked using GPS modules or a variety of other tracking mechanisms. An advertising notification for a specific store account is then outputted with the user PC device, if the user location is within the geofenced location of the specific store account. Thus, store accounts are provided with the opportunity to advertise goods and promotions to passersby. In an exemplary embodiment, store accounts are prompted with an upgrade option that enhances the range and volume of promotions sent to different user accounts at a predetermined rate.

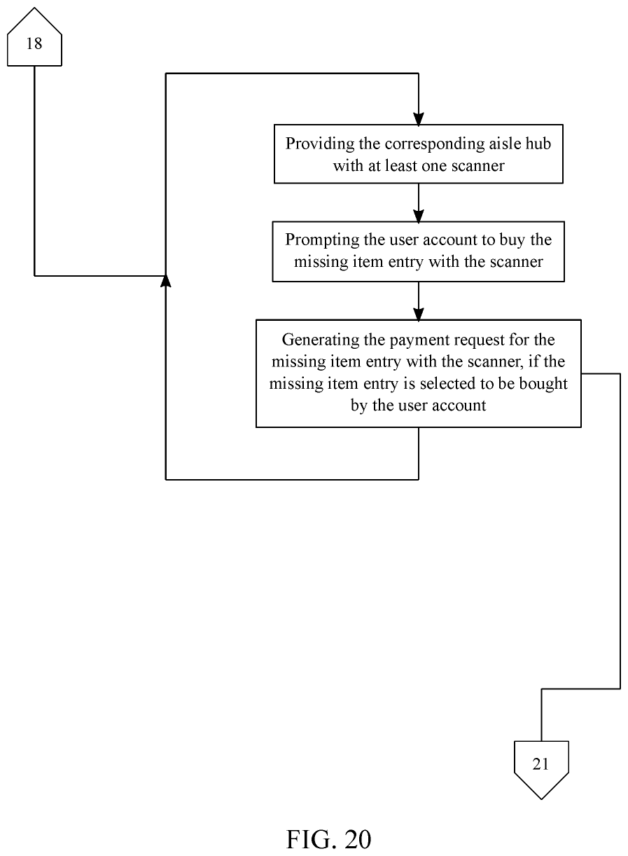

A user account may wish to complete a purchase in person at a store. To allow for this, the corresponding aisle hub is provided with at least one scanner, as represented in FIG. 20. The at least one scanner relates to a device capable of reading QR codes, barcodes, and the like and converting the results into a communicable format. Next, the user account is prompted to buy the missing item entry with the scanner. This connection may be made through the remote server or directly with the scanner. Finally, the payment request for the missing item entry is generated with the scanner, if the missing item entry is selected to be bought by the user account. In this way, the user may complete the purchase of an item without leaving the store.

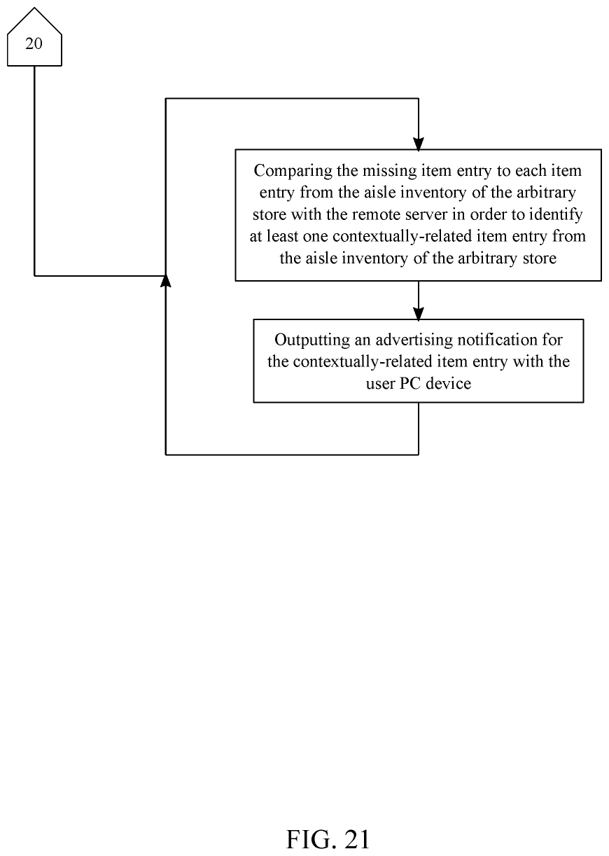

While a user is shopping through a store, the user may cross items off of their shopping list, which connects to the application of the present invention. This enables the store to respond to the user account's progress while shopping. Furthermore, a user's shopping history may be utilized to achieve a similar effect. To enable this feature, the missing item entry is compared to each item entry from the aisle inventory of the arbitrary store with the remote server in order to identify at least one contextually-related item entry from the aisle inventory of the arbitrary store, as represented in FIG. 21. In this way, items similar to the items on a user account's shopping list may be identified. Next, an advertising notification for the contextually-related item entry is outputted with the user PC device. In this way, the user becomes aware of items that the user may be interested in.

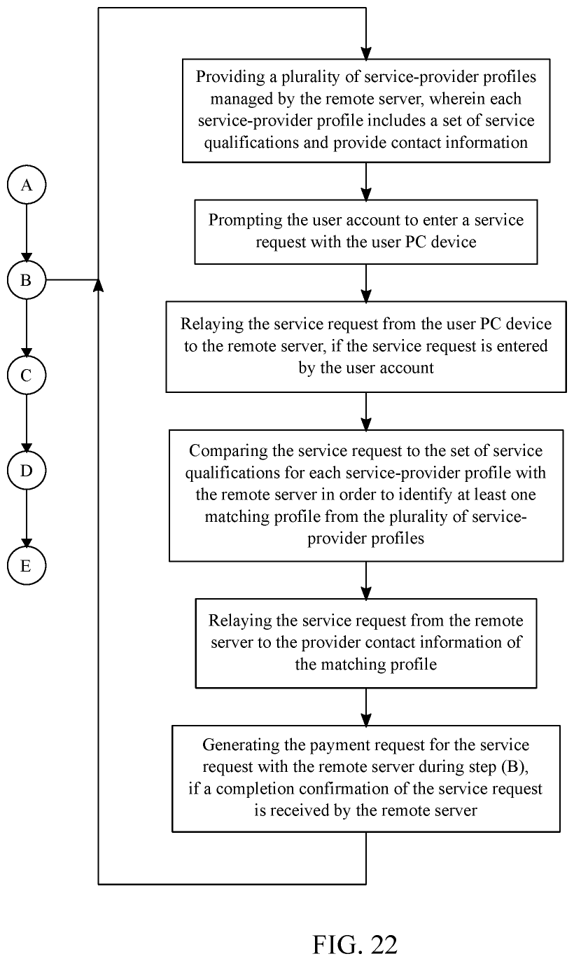

Many organizations provide their clients with services, such as housing maintenance services, business development services, general management services, and more, and require a system to facilitate client communication. To this end, a plurality of service-provider profiles managed by the remote server is provided, wherein each service-provider profile includes a set of service qualifications and provide contact information, as represented in FIG. 22. The set of service qualifications relates to any certifications, degrees, licensure, or other such items that confirm the validity of the business. The user account is next prompted to enter a service request with the user PC device. The service request may be a keyword search for a specific service required at a given time, such as internet maintenance or house painting, and may further include information such as location, preferred times and dates, and preferred pricing range. Subsequently, the service request is relayed from the user PC device to the remote server, if the service request is entered by the user account. In this way, the remote server is able to document and analyze the submitted request and send an appropriate response. The service request is compared to the set of service qualifications for each service-provider profile with the remote server in order to identify at least one matching profile from the plurality of service-provider profiles. The remote server may use information such as proximity, qualifications, desired price range, and more in order to decide which service-provider profile may fit within the at least one matching profile. Then, the service request is relayed from the remote server to the provider contact information of the matching profile. This enables the matching profile to be aware of their client's desired appointment. Finally, the payment request for the service request is generated with the remote server during Step B, if a completion confirmation of the service request is received by the remote server. In this way, the full transaction and appointment handling may be coordinated by the remote server.

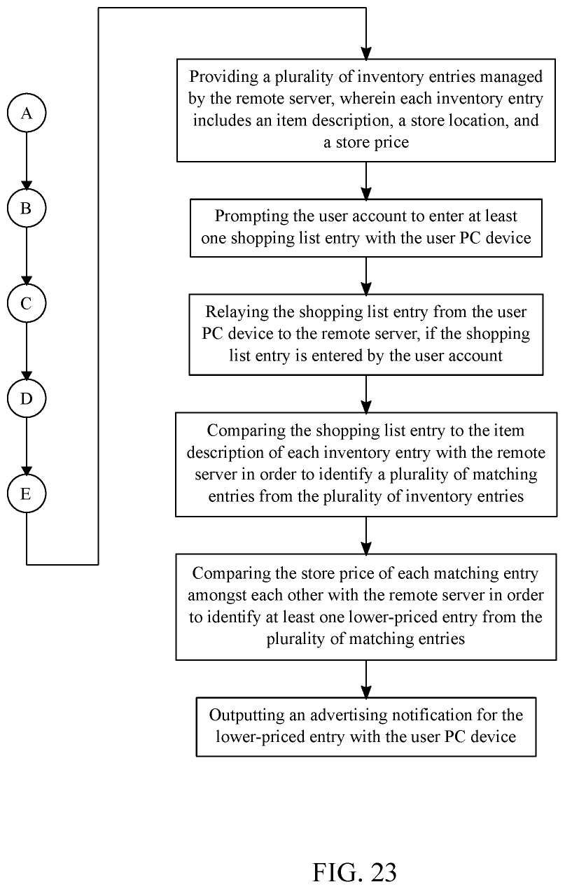

A user account may include a shopping list feature that assists the user account in preparing for grocery shopping, or other types of shopping. To provide this, a plurality of inventory entries managed by the remote server is provided, wherein each inventory entry includes an item description, a store location, and a store price, as represented in FIG. 23. The plurality of inventory entries assembles into an updating database of available items for subsequent use by the remote server. The user account is prompted to enter at least one shopping list entry with the user PC device. The at least one shopping list entry may be autocompleted by the remote server based on analysis of the purchasing history of the user account. The shopping list entry is then relayed from the user PC device to the remote server, if the shopping list entry is entered by the user account. Thus, the remote server may store the at least one shopping list entry. The shopping list entry is compared to the item description of each inventory entry with the remote server in order to identify a plurality of matching entries from the plurality of inventory entries. This arrangement enables the remote server to connect the items on the shopping list with items available in nearby stores. Next, the store price of each matching entry is compared amongst each other with the remote server in order to identify at least one lower-priced entry from the plurality of matching entries. This lower-priced entry represents the most desirable product to show to the user account and may be identified using a variety of sorting algorithms. Finally, an advertising notification for the lower-priced entry is outputted with the user PC device. In this way, the user becomes aware of the best prices in the area and may make shopping decisions accordingly.

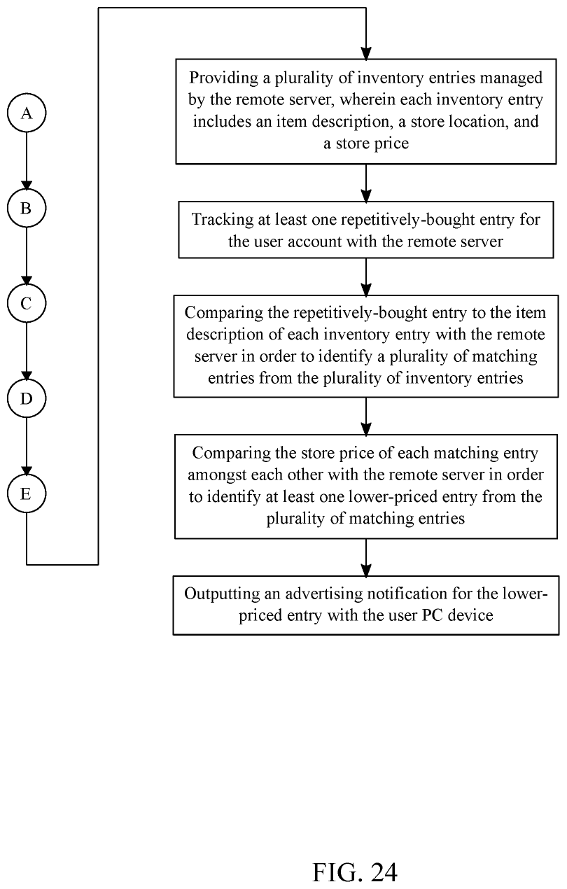

The application of the present invention may further be equipped to react to the needs and habits of the user account. To accommodate for this, a plurality of inventory entries managed by the remote server is provided, wherein each inventory entry includes an item description, a store location, and a store price, as represented in FIG. 24. The plurality of inventory entries assembles into an updating database of available items for subsequent use by the remote server. At least one repetitively-bought entry for the user account is tracked with the remote server. The remote server or the user account may determine the minimum requirements for receiving consideration as a repetitively-bought item. The repetitively-bought entry is compared to the item description of each inventory entry with the remote server in order to identify a plurality of matching entries from the plurality of inventory entries. This arrangement enables the remote server to identify available items that the user account may be interested in. Next, the store price of each matching entry is compared amongst each other with the remote server in order to identify at least one lower-priced entry from the plurality of matching entries. In this way, the remote server determines items which have gone on sale or had prices lowered on behalf of the user account. Then, an advertising notification for the lower-priced entry is outputted with the user PC device. Thus, the user account displays commonly-purchased items that the user account has shown interest in in the past.

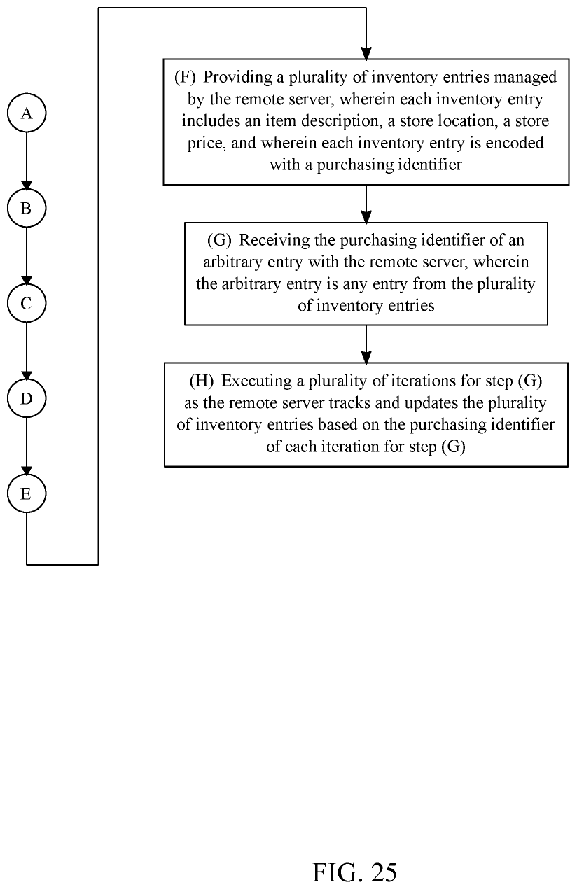

The remote server is capable of tracking and updating store prices as store prices change. To enable this process, a plurality of inventory entries managed by the remote server is provided, wherein each inventory entry includes an item description, a store location, a store price, and wherein each inventory entry is encoded with a purchasing identifier (Step F), as represented in FIG. 25. Each of the store location, the item description, the store price, and the purchasing identifier is noted as being either constant or fluctuating and is subsequently monitored accordingly. The purchasing identifier of an arbitrary entry is received with the remote server, wherein the arbitrary entry is any entry from the plurality of inventory entries (Step G). In this way, the remote server becomes aware of the presence of new items within a store and updates the database accordingly. Then, a plurality of iterations for Step G is executed as the remote server tracks and updates the plurality of inventory entries based on the purchasing identifier of each iteration for Step G (Step H). Thus, the remote server is updated constantly with new information regarding the presence of items and any changes in pricing.

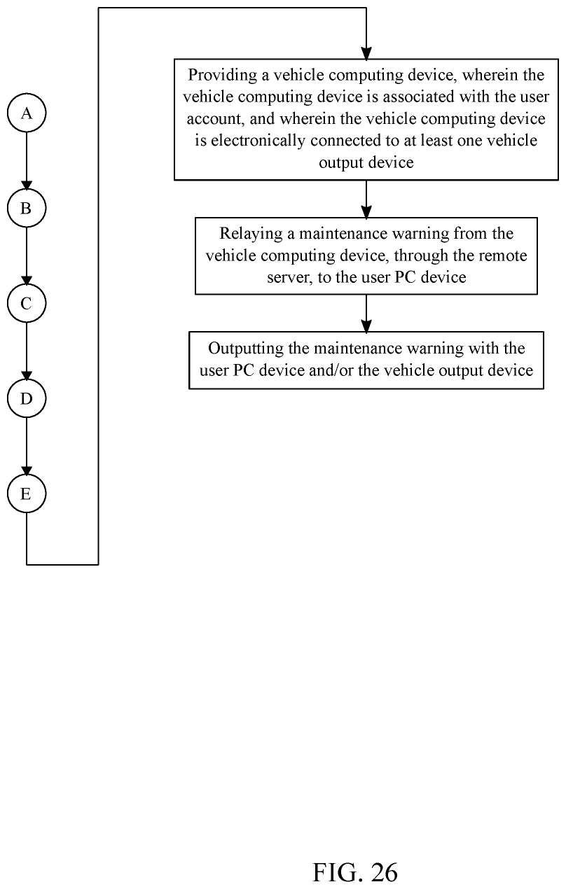

Many users encounter issues with their vehicles while driving and do not know what to do or how to appropriately address the situation. To address this issue, a vehicle computing device is provided, wherein the vehicle computing device is associated with the user account, and wherein the vehicle computing device is electronically connected to at least one vehicle output device, as represented in FIG. 26. The vehicle computing device may relate to any onboard computer or processor capable of wirelessly connecting to the remote server. A maintenance warning is relayed from the vehicle computing device, through the remote server, to the user PC device. This maintenance warning may include information including diagnostics or parts that must receive attention. The maintenance warning is outputted with the user PC device and/or the vehicle output device. This arrangement enables the user account to receive relevant information regarding the status and condition of the user's vehicle while driving and to be notified quickly, thus enabling a quick, effective response. The remote server may further provide suggestions for mechanics or garages capable of performing the required maintenance, or else suggestions for roadside assistance services.

Oftentimes, the user may wish to utilize the present invention using voice commands or the like. To this end, the user PC device manages an automated personal assistant service. The automated personal assistant service relates to a voice-activated and voice-responsive system that can answer questions and communicate with the remote server to answer various questions and perform various tasks. The user may also order items using the automated personal assistant service.

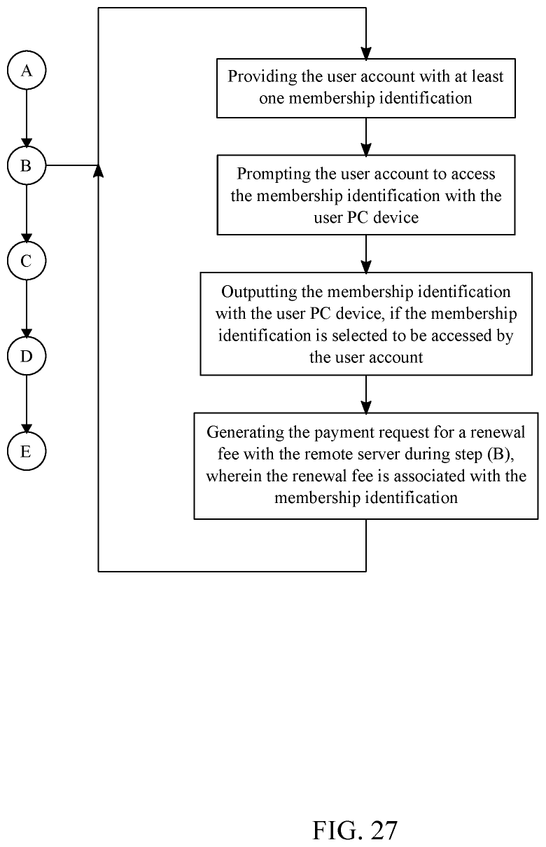

The user may attend a variety of different clubs, gyms, or similar locations, and may wish to manage memberships from a single location. To achieve this, the user account is provided with at least one membership identification, as represented in FIG. 27. The at least one membership identification relates to the barcodes, QR codes, identification numbers, or other such tools that enable a user to gain entry to restricted locations. The user account is prompted to access the membership identification with the user PC device. This arrangement allows the user to access the relevant membership information at the appropriate time. Next, the membership identification is outputted with the user PC device, if the membership identification is selected to be accessed by the user account. Thus, the user PC device displays the information necessary for the user to gain entrance to a restricted area. The payment request for a renewal fee is regularly generated with the remote server during Step B, wherein the renewal fee is associated with the membership identification. In this way, the user may manage the membership information entirely through the application of the present invention.

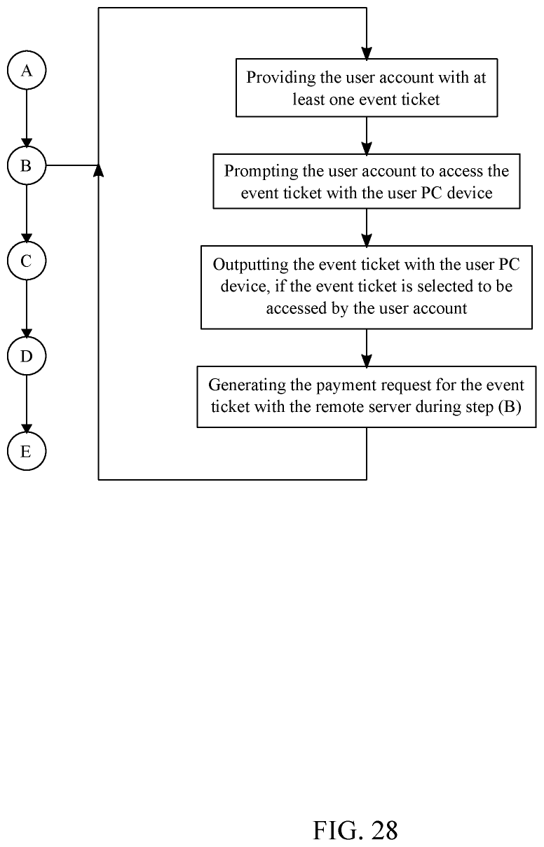

The user may wish to manage tickets and events directly from a centralized location as well. To provide for this, the user account is provided with at least one event ticket, as represented in FIG. 28. The at least one event ticket relates to a purchased permission associated with an event that thus allows the user to gain entry to that event. The user account is then prompted to access the event ticket with the user PC device. In this way, the user can store tickets and ticket information in the remote server until the user is prepared to display that information. The event ticket is then outputted with the user PC device, if the event ticket is selected to be accessed by the user account. This arrangement allows the user to show the user PC device to a security guard in order to gain access to an associated event. Finally, the payment request for the event ticket is generated with the remote server during Step B. In this way, the payment request can also be fulfilled directly through the application of the present invention.

Although the invention has been explained in relation to its preferred embodiment, it is to be understood that many other possible modifications and variations can be made without departing from the spirit and scope of the invention as hereinafter claimed.

### Supplemental Description

The main feature of the present invention is that all the user's cards are all one platform, however many cards they may have. While shopping either online, grocery store, gas station etc., an algorithm will choose the right card for the right purchase so it will save the user time and money. We will provide a payment card so our customers will not need to carry all their credit cards and debit cards all the time. User can just use one card for every purchase. Also, the algorithms while shopping online will search the web and online stores for the best deal, discounts and add them to their shopping cart whichever site they're shopping.

While getting gas the user can use the Blueinfiniti payment card and the algorithm will choose the right card for purchasing for gas. It will also choose the right card for food, clothes, flights, car rentals etc.

All the user's points they generated will be loaded onto our platform and can be viewed at any time. Offers will be sent to the Blueinfiniti platform so the user can view deals, discounts, flights for the user's points, etc.

In summary, our platform will search the web for deals discounts and choose the right card for the right purchase so our customers will save time and money. Main features include:
1. Digital Wallet
2. Payment Card Cancellation and Reorder
3. Phone-to-Phone Payment Transfers
4. 3-Click Payment
5. Cloud Payment System
6. Travel Notification
7. Online Card Activation
8. SMS Transaction Alerts
9. Financial Statements
10. Income Tax Calculator
11. Blueinfiniti for Businesses
12. Mile Tracker
13. Payment Card Barcode
14. Payment Card GPS Chip
15. State-to-State Payment
16. Travel Funds
17. Card Access Management (Locking)
18. Digital Bills & Automatic Payment
19. Biometrics Authentication
20. Voice Commands
21. 4-Digit Passcode
22. Screenshot Security
23. High Security
24. Coupons redirected when using a certain credit card *Member Benefits?
25. Budget Management
26. Blueinfiniti internet video
27. Paperless Bank Statements
28. Phone number
29. Booking hotels
30. Booking flights
31. Car rentals

Regarding the business model, Blueinfiniti.ca is a digital platform that offers online users a highly secure application to manage their banking, expenses, spending, and member benefits. Our mission is to create convenience, efficiency, and security through a multitude of application features. Blueinfiniti empowers its users by enabling them to act swiftly in the event of fraudulent banking activity. Our company simplifies the action steps required to mitigate these risks by allowing users to cancel and reorder their payment cards directly through the app, eliminating the need to contact or visit their banking institution. Blueinfiniti values the privacy of our users' personal details and aligns with high-security initiatives that are proven effective in the banking industry. Generated passcodes and biometric authentication ensure that accessibility to the app is limited to the user of the account. Additionally, the front-facing camera to the user's mobile device will trigger a photo capture in the event of multiple access attempts, deterring access to unauthorized parties.

Blueinfiniti seeks to affiliate with financial institutions in an effort to reduce global fraud and increase user satisfaction, by giving users peace of mind that their personal details are safe and secure. Our company offers solutions that combat fraudulent activity, ultimately reducing costs for banks and credit card companies, saving them millions of dollars per year. User interaction through the Blueinfiniti app will minimize outgoing customer service complaints to our affiliated partners, saving them on time which they can then allocate towards more important concerns or projects.

Blueinfiniti strives for high usability and focuses on creating a user experience that is fast, easy, and enjoyable. Our processes are streamlined and in just a few clicks, our users are in total control of their transactions. Additional features allow our users to manage bookings and receive confirmations or itineraries for hotels, flights, and car rentals. Providing up-to-date information to our users is of utmost importance; in-app notifications will alert the users of important messages from our affiliates including estimated delivery dates, delays, or promotional offers.

The present invention is a digital platform, accessible via mobile or desktop application, that offers online users a highly secure system to manage their banking, expenses, spending, and member benefits. Registered users become Blueinfiniti cardmembers and use this credit card for all of their purchases as a substitute for their existing payment cards. Blueinfiniti functions as a smart card, as its application relies on highly sophisticated algorithms and automated reasoning to sort each transaction to the user's preferred method of payment. For example, Debit Card A may be used for grocery store purchases while Credit Card B takes care of the user's gas on the go. The Blueinfiniti application incorporates banking, accounting, security, budgeting, booking, and shopping features.

Blueinfiniti has two components, including the Blueinfiniti credit card and the Blueinfiniti platform. Application features and functions are as follows:
1. Digital Wallet
2. Payment Card Cancellation and Reorder
3. Phone-to-Phone Payment Transfers
4. 3-Click Payment
5. Cloud Payment System
6. Travel Notification
7. Online Card Activation
8. SMS Transaction Alerts
9. Financial Statements
10. Income Tax Calculator
11. Blueinfiniti for Businesses
12. Mile Tracker
13. Payment Card Barcode
14. Payment Card GPS Chip
15. State-to-State Payment
16. Travel Funds
17. Card Access Management
18. Digital Bills & Automatic Payment
19. Biometrics Authentication
20. Voice Commands
21. 4-Digit Passcode
22. Screenshot Security
23. High Security
24. Member Benefits
25. Budget Management
26. Blueinfiniti Internet Video
27. Paperless Bank Statements
28. Phone Number
29. Booking Hotels
30. Booking Flights
31. Car Rentals

Blueinfiniti empowers its users by enabling them to act swiftly in the event of fraudulent banking activity. Our company simplifies the action steps required to mitigate these risks by allowing users to cancel and reorder their payment cards directly through the app, eliminating the need to contact or visit their banking institution. Blueinfiniti values the privacy of our users' personal details and aligns with high-security initiatives that are proven effective in the banking industry. Generated passcodes and biometric authentication ensure that accessibility to the app is limited to the user of the account. Additionally, the front-facing camera to the user's mobile device will trigger a photo capture in the event of multiple access attempts, deterring access to unauthorized parties.

Blueinfiniti seeks to affiliate with financial institutions in an effort to reduce global fraud and increase user satisfaction, by giving users peace of mind that their personal details are safe and secure. Our company offers solutions that combat fraudulent activity, ultimately reducing costs for banks and credit card companies, saving them millions of dollars per year. User interaction through the Blueinfiniti app will minimize outgoing customer service complaints to our affiliated partners, saving them on time which they can then allocate towards more important concerns or projects.

The present invention differs itself than what currently exists, because Bank of America, Chase, Wells Fargo, and Capital One are all recognized for their effective mobile banking apps. However, Blueinfiniti is a novel concept because this application exceeds the parameters of these existing apps. The scope of Blueinfiniti's features are much greater and does not limit itself to basic functions such as bill payments and money transfers. Earlier this year, Entersekt, a South Africa-based fintech provider, released initial findings regarding a survey they conducted with The Harris Poll. Gathered data revealed that 68% of regular banking app users would “like to do all banking and payments via one single mobile app.” Younger adults between the ages of 18-44 years expressed the greatest interest in an application with combined features. The market deserves an all-in-one solution that eliminates the need to juggle separate apps for banking, payments, budgeting, accounting, booking, and shopping. Blueinfiniti desires to satisfy this opportunity in the market and differentiates from its competitors via specialized algorithms and automated reasoning.

Blueinfiniti's platform will be made available for installation through participating app stores and accessible via mobile or desktop application. Upon registration, users will be issued their Blueinfiniti credit card and receive it via post. Their credit card can be authenticated directly through the app and used immediately afterwards to make transactions and earn rewards points. Access to the app is granted through biometrics authentication and functions can be used through voice commands, search tools, and touch-based navigation and prompts. Keyboard input is minimal, improving ease of use.

The Blueinfiniti platform will be developed by an application developer using HTML5, which supports offline data, as well as rich media including audio and video.

Algorithms will be incorporated to produce automated reasoning, allowing for smart features such as Card Access Management which recognizes how to sort a user's purchases to the appropriate payment method.

Features of the application include:

### 1) Digital Wallet

Blueinfiniti allows the user to store all of the user's payment cards onto the app and displays useful information including expiry dates and account balances. Users can set their default preferred method of payment and have the flexibility to switch between cards while shopping.

How it Works
1. Scan each card into the app using the user's mobile camera
2. Select which card the user would like as the user's default payment
method 3. Open the feature and tap for contactless payment at a merchant's terminal in-store

### 2) Payment Card Cancellation and Reorder

In the event of a lost or stolen debit or credit card, simply log into Blueinfiniti through the mobile app, cancel the user's existing card and reorder a new one. The user's financial institution will be notified of the request and once authorized the user will receive an email and mobile notification confirming the user's card cancellation and reorder, including an expected date of arrival for the user's replacement card.

Similarly, in the event of a damaged card simply log into Blueinfiniti through the user's mobile app and select the payment card the user wishes to be replaced. Indicate the reason for the user's replacement request and wait for the user's confirmation email and notification informing the user of the cancellation of the user's current card and expected date of arrival for the user's replacement card.

Blueinfiniti will also alert the user when the user is approaching the expiry date of a payment card, so that the user can order a new card while maintaining accessibility to the user's current one until the date of expiry.

In the event of a lost mobile device, the user will be able to log into the user's Blueinfiniti app on any smartphone with the downloaded app or through the web-version on a computer. Login through a smartphone will require fingerprint authentication in order to access the user's account and card details.

How it Works
1. Open the Blueinfiniti app and digital wallet feature
2. Select the card the user wishes to cancel and reorder
3. Indicate reason and submit the user's request
4. Receive confirmation of cancellation and reorder via email and mobile notification
5. Stay up-to-date with notification alerts that remind the user of upcoming card expiry dates

### What it Resolves: Card Replacements

Blueinfiniti's mission is to smooth out the customer experience in relation to lost, stolen, or damaged debit and credit cards. In 2014, 42% of Americans lost their bank cards. For example, if the user lost the user's wallet that had payment cards with different banking institutions, the user would then have to phone each institution to report the user's incident and cancel the user's card. This equates to many long and often stressful conversations with one or more customer service representatives. On average, it takes around 8 minutes to speak with a CSR. Without a 16-digit card number this time will take longer as the user will need to provide additional information to pass through all of the security questions. Assuming the user go through this process with multiple cards and companies, it is now taking over an hour out of the user's day to address the user's concern. Furthermore, the user is then subject to multi-step automated voice prompts, followed by long scripted sales pitches by the CSR at the end of the user's call, regarding new products and services.

Blueinfiniti values the user's time. Through our app the user can skip the automations, on-hold classical music, leapfrog of customer service representatives, and scripted sales pitches. Just login, select, submit, and receive confirmation.

### 3) Phone-to-Phone Payment Transfers

Phone-to-Phone Payment is a faster way to transfer money while the user is on the go and with the person the user would like to complete a transfer with. Log into Blueinfiniti through the user's smartphone, open the feature and input the user's details into the required fields. Activate the Bluetooth sync options and wait a moment as the user and the recipient's phones pair together. Once the sync is successful, confirm the outgoing of funds. Once the transfer has been accepted by the other person, the funds will transfer immediately, and the transaction is complete.

How it Works
1. Input name
2. Input email address
3. Input mobile number
4. Select card
5. Input amount
6. Hit send
7. Save details for future transfers

### What it Resolves: Inefficient Transfers

Completing a transfer through online banking can take too long due to long forms. Often there are technical issues that delay the process. Input errors or incorrect security question answers result in declined transactions. Sometimes it can take multiple attempts to correct the information before the transfer is successful. Blueinfiniti's feature is simple and by allowing the user to save a recipient's details, future transfers become even quicker. No more running to the ATM or carrying cash on you.

### 4) 3-Click Payment

Blueinfiniti wants to make the user's online shopping experience quick and easy. As you're browsing an online retailer, the user will be able to select the item the user wants to purchase. That item will then transfer into a cart on the Blueinfiniti app. The user can continue browsing and adding items. Once the user is ready to confirm the user's purchase click on the Blueinfiniti logo present on the online retailer's page and the user will be redirected to our app where the user can review and remove items. Since all of the user's payment details and shipping addresses are already stored in the app, all the user needs to do is select the user's payment card when the user is ready. This will automatically complete the transaction and an email confirmation will be sent out to you.

How it Works
1. Browse online retailer
2. Click item. Item automatically adds to Blueinfiniti cart.
3. Click Blueinfiniti logo when the user is ready to view cart
4. Redirected to Blueinfiniti application
5. Click preferred card for payment
6. Receive email confirmation

### What it Resolves: Multi-Page Online Checkouts

Many online retailers still require the user to input the user's card details, billing address, and shipping address every time the user shop. This process forces many customers to go searching for their wallet in order to grab their card details for the checkout of their items. Blueinfiniti's ability to log a user's details make purchases as easy as 1-2-3.

### 5) Cloud Payment System

Blueinfiniti will have a cloud storage system for transaction payments. When the user has confirmed payment for the user's online shopping, this outgoing amount will leave the user's bank account and be sent to our cloud payment system. The seller will be notified that funds for the purchase are sufficient. Each purchase will be generated a unique barcode for postal service and tracking purposes. Once the package has been scanned for, upon arrival at the recipient's address, their money will be released from the cloud and successfully transferred to the seller.

How it Works
1. Shop online through 3-Click Payment process
2. Click payment through the Blueinfiniti app
3. Payment leaves the user's account to our cloud storage system
4. Confirmation is sent to seller informing them of available funds
5. Seller releases the product or service
6. Item is scanned for upon arrival at the buyer's address
7. Monday is automatically released to the seller

### What it Resolves: Seller Scams & Missing Parcels

Our cloud payment system ensures that a buyer does not need to completely part with their money until they have received their promised goods. This system deters fraud and reduces scams by allowing a buyer to cancel their payment at any time if they believe that the seller is practicing unethical business practices. It also protects a seller because once the item is scanned as delivered, they will receive the funds, knowing that the parcel was successfully received by the buyer. This prevents any false claims of missing packages.

### Managing Customer Concerns

Buyers can raise any concerns by opening up a case through the Blueinfiniti app. To do so, the buyer will select their purchase, indicate their reason for dissatisfaction and preferred method of resolution, then submit their concern. Our Customer Care Centre will help to resolve issues effectively and efficiently, so the user don't have to. Our team will review the user's case and contact the seller regarding refunds, returns, or faulty products.

### Refunds

Blueinfiniti will reimburse $20 USD for refunds, covering costs of shipping on returned items including:
1. Items that do not meet quality standards
2. Damaged goods
3. Product does not match item description
4. Buyer changes their mind

### 6) Travel Notification

Blueinfiniti's Travel Notification feature enables users to enter in their departure and return dates, as well as their destinations, thus informing their credit and debit card companies of their time abroad. If the user is a frequent flyer, the user will be able to enter multiple trips well in advance, ensuring that the user will have less to worry about come the day of the user's departure. At Blueinfiniti, we understand that sometimes plans change and the user may want to shorten or extend the user's trip and that's not a problem! The user can edit the user's dates at any time and the user's financial institutions will be informed of the changes that way the user doesn't have to stress about the user's card being blocked.

How it Works
1. Click Travel Notifications
2. Enter date of departure
3. Enter date of return
4. Select the user's destination
5. Receive email confirmation

### What it Resolves: Account Freezes

Travel worry-free! Through our Travel Notification feature the user can rest assured that the user's bank is informed, and the user's money is accessible to the user as the user travel.

### 7) Online Card Activation

Blueinfiniti makes activating the user's new or replacement cards easy! Once you've received the user's mail containing the user's new card, open our app and scan the user's new card using the user's mobile camera. The user's card will store into the user's digital wallet where the user can now click on it and select the activation button. Once activated, the user will be ready to use the user's card and the bank will be notified of its activation.

How it Works
1. Open Blueinfiniti app
2. Scan card with mobile camera
3. Select card from digital wallet
4. Click activate
5. Receive email confirmation

### What it Resolves: Customer Service Wait Times

Our Online Card Activation feature eliminates the need to contact the user's bank and spend unnecessary time responding to automated prompts.

### 8) SMS Transaction Alerts

Blueinfiniti will send SMS Transaction Alerts any time one of the cards in the user's digital wallet has been used, whether in-store or online. SMS Transactions Alerts will notify the user of the card used, transaction amount, time of transaction, and location of transaction.

How it Works
1. Transaction is made
2. SMS Transaction Alert goes out to the user's mobile device
3. Notified of card and transactions details

### What it Resolves: Fraudulent Transactions

Receiving SMS Transaction Alerts enable users to act fast when it comes to theft and fraudulent transactions. If the user receives an alert notifying the user of an unfamiliar transaction, the user can click a hyperlink within the message that will redirect the user to that card within the user's digital wallet. Then the user can click an option that allows the user to freeze the user's account and report the suspicious activity to the user's bank for further investigation. Often this type of theft goes unnoticed because the culprit withdraws or purchases small amounts that would not stand out on a bank statement, and many people do not review their statements regularly. Receiving these alerts ensures that Blueinfiniti users and always aware and in control of their money.

### 9) Financial Statements

Blueinfiniti will store all of the transactions from the cards in the user's digital wallet and collect the information into Financial Statements. This feature will calculate the user's spending and generate daily, weekly, monthly, and yearly reports. These charts will help the user to understand how and where the user spend the user's money.

How it Works
1. Open the Blueinfiniti app
2. Go to the Financial Statements feature
3. Select Daily, Weekly, Monthly, or Yearly Report
4. View the user's Financial Statement with option to save .pdf version to the user's device

### What it Resolves: Overspending

Blueinfiniti wants its users to be able to access insights about their spending. Financial Statements provide users with a visual representation of their buying behaviors. This benefits approximately 65% of the population who identify as visual learners. Charts that reveal where we invest our resources can help us to curb any excessive spending.

### 10) Income Tax Calculator

Blueinfiniti provides users and businesses with a bookkeeping platform that relies on highly skilled AI Machine Learning Technology to collect transaction details and history, and calculate the user's federal taxes, provincial taxes, and income tax refund. Blueinfiniti provides 24/7 accounting support through its Customer Care Centre.

How it Works
1. AI-powered software will process and categorize financial transactions
2. Transactions are pushed and stored into the user's Blueinfiniti File
3. Machine learning technology analyzes the user's bookkeeping data
4. Reports, insights, and budget controls are automatically delivered to the user's inbox
5. Data is extracted from both financial and non-financial sources
6. Categorizes expenses, accrued revenues, and invoices into reports
7. Tax forms will be provided by Super Tax and H&R Block

### What it Resolves: Penalties & Tax Evasion

General Public
Unfiled taxes are the most common cause for incurred fines, penalties, and legal punishments relating to taxes. The IRS considers this tax evasion and fines can go up to $10000. Inability to pay a secondary cause and those affected by this face penalties and interest.

Business
Businesses must keep their bookkeeping records in excellent and accurate condition, while keeping track of all their receipts and expenditures. They must also abide by federal and state regulations and tax codes. If this is done incorrectly, businesses may face penalties and fines by the IRS. Filing taxes can be confusing and time consuming, which is why businesses often hire an accounting firm to do the work for them.

Blueinfiniti can store, calculate, analyze, and summarize the user's financial data. The platform's automated features ensure that accurate calculations and deductions are formulated so that the user do not need to seek an accountant come tax season or pay hefty fees for their services. By having the information and tools at the user's fingertips, the user can have the confidence to file the user's taxes accurately and on time every year.

### 11) Blueinfiniti for Businesses

Blueinfiniti's easy-to-use software allows the user to manage the user's own business finances. Accounts will be up-to-date, accurate, and accessible. Blueinfiniti stores everything in one place, making it easier for the user to view and share the user's data such as:
1. Payroll
2. Accounts Payable
3. Financial Reports
4. Tax Filing
5. Expense Management
6. Accounts Receivable
7. Cash Forecasting

How it Works
1. Store the user's credit and debit cards onto the app
2. Automatically imports and categorizes transactions
3. Transaction receipts will be stored in the app
4. Send and track invoices
5. Separate business and personal expenses
6. Automatic quarterly tax calculations
7. View profit margin
8. Track expenses and earned income
9. Manage bills
10. Track payroll
11. Track inventory
12. Automate mortgage payments
13. Create and manage budgets
14. Customer Care Centre support accessible 24/7

### 12) Mile Tracker

Mile tracker will use the user's smartphone to reliably and automatically track the date, destination, and distance the user's motor vehicle has travelled for business trips within a fiscal period. This feature allows the user to label the purpose for each trip so that the user can maintain an accurate log of the user's business travel to present when the user claim the user's business expenses.

### 13) Payment Card Barcode

Payment cards featuring a unique cardholder identification barcode can be scanned into the Blueinfiniti app, providing a contact phone number for the cardholder. This feature allows people who find lost cards to contact, inform, and return the card to the designated cardholder.

How it Works
1. Use mobile camera to scan barcode into the Blueinfiniti app
2. The cardholder's contact phone number will display
3. Click hyperlink to make a phone call
4. Return lost payment card

### 14) Payment Card GPS Chip

Payment cards featuring a unique GPS chip can be tracked using the Blueinfiniti app. This feature helps to locate lost or stolen cards.

How it Works
1. Log into the Blueinfiniti app on the user's smartphone
2. Click Find My Card feature
3. GPS system will indicate the exact location of the user's missing card(s)

### 15) State-to-State Payment

Residents of the United States experience account freezes by their bank any time a payment is made to an account in a different state. These account freezes occur to prevent fraud, but this action imparts delays and inconvenience on that of the purchaser.

Blueinfiniti makes payments between states easier by allowing the user to submit a permission request to the user's financial institution before completing a transaction.

How it Works
1. Log into the Blueinfiniti app and select State-to-State Payment feature
2. Input the state the user requires to make a payment to
3. Input the name of the business or recipient of the payment
4. Input payment amount
5. Select date
6. Confirm request details
7. Receive email confirmation

### 16) Travels Funds

Blueinfiniti makes the user's financial security our top concern. As such, we have come up with a solution to ensure that the user have accessibility to the user's funds while travelling abroad in the event of a missing, stolen, or damaged card. Firstly, the user can use the app to cancel and reorder a replacement card. Once the user's request is approved, the user will receive an email with the user's new card details. Next, input and store the user's new card into the digital wallet. Then the user can continue making transactions through the contactless “tap to pay” method at merchant terminals.

Secondly, the user can request emergency funds from the user's bank through the Blueinfiniti app. The user's bank will provide a reference number to you, through the app, that will be assigned to the user's emergency funds. Use this reference number at a local bank in the country the user is travelling to obtain the emergency funds from the user's account.

How it Works
1. Cancel card and order replacement card through the Blueinfiniti app
2. Receive email with new card details
3. Input new card details into digital wallet
4. Use the user's smartphone to pay contactless

or
1. Cancel card and order replacement card through the Blueinfiniti app
2. Request emergency funds from the user's bank through the Blueinfiniti app
3. Receive a reference number from the bank
4. Go to local bank with reference number
5. Obtain emergency funds

### 17) Card Access Management

Blueinfiniti allows the user to manage access to all of the cards within the user's digital wallet by setting them to lock or unlock. This feature allows the user to set an automatic timer. For example, the user could set an automatic lock timer to 10 minutes. This means that the user's card will automatically lock within 10 minutes of the user's last transaction. Any activity that occurs while the user's cards are locked will be notified to the user through an SMS alert.

How it Works
1. Log into Blueinfiniti app and view digital wallet
2. Click Lock icon next to each card to toggle between lock and unlock
3. Set automatic lock timer to desired amount of minutes
4. Set time to automatically activate daily Night Lock Mode
5. Receive SMS alerts for suspicious activity during Lock Mode

### What it Resolves: RFID Skimming

RFID skimming refers to a type of electronic pickpocketing that criminals use to obtain payment card information and commit Card Not Present Fraud. Incidents of this form of fraud has increased rapidly within the last decade. Most cardholders are unaware of these transactions as most fraud occurs between the hours of 2-6 am. The ability to lock the user's cards will disable this type of theft.

### 18) Digital Bills & Automatic Payment

### Explain the Problem

Everybody has bills to pay, people forget, they get multiple letters and when it comes to paying them it's a hassle, going online to the post office are where they pay their bills. It takes time to do the process of billing a load of bills and on time also.

How does the Product Solve it?

Load all the user's bills onto the Blueinfiniti platform. With an easy to use platform that the user's bills will already setup on you're the Blueinfiniti platform and when they are due for payment. It will eliminate posts coming to the user's house. When the user's bills come onto the Blueinfiniti platform the user will get a message alert stating that a bill is due. With the user's main card as payment.

The user can have automated bills payment setup for the user's mortgage, cell phone etc., with email confirmation to inform the user of the transaction.

How it Works
1. All bills on one platform
2. Automatic bill Pay
3. Text alert for up and coming bills
4. Easy pay
5. One clicks payment
6. Bill tracking
7. Check balances on bills
8. Receipts
9) International Paying

### Explain the Problem

With a serous of lengthy online forms to fill out, with high fees for international money transfers. It is very time-consuming process. With a number of bank codes from the banks to be entered in that the person that is receiving the money has to ring up the banks for.

How does the Product Solve it?

Go onto the Blueinfiniti platform enter the person name, email, phone number, the amount the user wants to send them. When the person receives the money, they can accept the money with their four-digit access pin that will automatically generated by Blueinfiniti platform and sent as message alert for them the user enters to receive the money.

How it Works
1. Name.
2. Email.
3. Amount.
4. Country
5. Phone email
6. Easy pay

### 20) Buying Vacations Online

When buying a vacation online it is a lengthy process with all the user's information and the user's payment method to be inputted before the holiday is booked.

How does the Product Solve it?

When the user goes online i.e. sky scanner and looking to book a holiday all the user has to do is select the user's holiday then press the Blueinfiniti logo and then the user be transferred to the Blueinfiniti platform where the user's passport will be already up loaded. The user simply selects the passport information to input the user's details and then pay. All the user's details will be on the Blueinfiniti Platform, so no long input of information is required.

The user will get flight itinerary will be emailed to the user and a copy will be uploaded to the user's Blueinfiniti platform.

How it Works
1. Travel app
2. Select vacation, date, time, destination
3. Blueinfiniti logo press, redirects the user to Blueinfiniti platform
4. Attach personal information and attach passport
5. Book
6. Flight itinerary on Blueinfiniti platform
7. Email confirmation
8. Boarding pass on Blueinfiniti Platform no need for paper documents for flying

### 21) Booking Hotel

### Explain the Problem

When looking for room in a different country, state, city, is time consuming with all the user's details to fill in i.e. name, email and payment details.

### How the User's Product Solves it

When the user wants to pay for a room on booking.com the user selects the user's room in the location the user requires it to be in. Select the Blueinfiniti logo and the booking will transfer of to the Blueinfiniti platform with all the user's details on the platform the user auto fills the user's details and payment method press pay and the booking is done. There will be an email with the user's booking emailed to the user and a copy will be on the user's Blueinfiniti platform.

How it Works
1. Booking.com
2. Select room
3. Date, time, location
4. Press Blueinfiniti logo and redirects the user to the user's profile
5. Auto fill the user's details
6. And then select pay
7. Email confirmation/and copy of the user's booking will be on the user's platform

### 22) Car Hire

Booking a car over the Internet takes time and a long process with multiple of different options, dealers and a lengthy process to complete the user's order.

How does the Product Solve it?

When the user is looking for a rental vehicle all the user has to do is select the user's vehicle the user require, click Blueinfiniti pay and the vehicle details will go to the Blueinfiniti platform ready for the user to proceed. Fill in the date the user wants the vehicle and the time and date when the user returns the vehicle and where. And then auto fill the user's details to complete the user's purchase.

How it Works
1. Choose dealer and vehicle
2. Select Blueinfiniti platform
3. Enter date and return date
4. Click Blueinfiniti pay
5. Email confirmation

### 23) Blueinfiniti Card

With the Blueinfiniti card there is no need for any more details to be fill out with card details, name, address, shipment, the Blueinfiniti card has all the user's detail automated for payment online. Anything the user have to put the user's details into to buy anything. So, when the user's online all the user has to do is hit Blueinfiniti logo and just have to wait for the user's items to arrive. When taking the user's money out at an ATM the user will not receive any charges for taking the user's own money out.

### 24) Passport

On the Blueinfiniti platform the user will be able to up load the user's passport to the system for a faster way for paying for vacations. So, when you're on vacations and the user lose the user's passport the user will still be able to use the user's passport. You'll have to ring the embassy to get a reference number for the airport immigration and a crime number from the police station so have as of what happen.

How it Works
1. Upload passport for travel plans
2. Attach when finalizing the user's booking
3. If it's lost on vacation the user always has copy in an emergency

### 25) Fingerprint Security and Password

On smartphones in the modern ages of technology, fingerprint is one choice to secure the user's details and on the Blueinfiniti platform you'll have the options of finger security and a password option. You'll be able to choose whichever finger as the user's prepared choice. With the password an eight digit will be required with one upper cap, the rest small, and numbers.

### Cyber Security

Blueinfiniti will partner with highly experience cybersecurity companies to enhance top security for all our customers and towards the banks and credit card companies. 24/7 transaction monitoring, fraud prevention policies minimize the user's risk

### Fraud Prevention

Our top-class fraud prevention systems and intelligences works around the clock to keep our system and our customers details secure. Additionally, we will invest heavily, and partner will top class Internet security companies to reduce fraud and keep all our customers in safe hands.

### Data Security

With Blueinfiniti the user only needs to upload and link all the user's debt cards, credit cards and all information details to the user's Blueinfiniti once. We will automatically encrypt all the user's sensitive information and email communications with Secure Layer Protocol 3.0 and the highest encryption key length. All the user's information will be stored in a heavily secure server that will be protected 24/7 hours a day. It will be secure physically with a number of heavily educated technicians and electronically design with the h grade of protection to protect both the sellers and the buyers

### Account Holding Status

To keep the user's details up to date it is important we will communicate with the user via our message alert system via the user's smartphone text message, email, and on the user's Blueinfiniti platform to assure the user profile is up to date with a friendly remember.

### Potential Partnerships

1. IBM and Qualys
2. Netskope and Cylance
3. Endgame and Red Canary
4. ForeScount and Digital Defense
5. Recorded future and Fraudwatch
6. ZeroFox And Anomali ThreatConnect and ThreatQuotient
7. Ixia and Endace
8. DomainTools and Maltego
9. The More, The Merrier
10. AT&T Business
11. EyeLock

### Eye Access Lock and Unlock

Iris authentication is highly secure that fingerprint security because the fingerprint can be stolen. There is no two iris that are alike in the world, so this makes this the one of the highest levels of security protection that's on the market.

Blueinfiniti will introduce this technology to the platform so we have the ultimate security protection for all our customers and towards our clients.

Option three is eye access lock and unlock system so the user will have the choice security features. The user simple setup the user's eye protection on the Blueinfiniti app with our trusted partnership companies.

### Screenshot Security

### Explain the Problem

People snoop into people phones, partners, brothers, sisters and friends on a daily basis. When the user's phone is stolen are the user left it in a store, pub restaurant, people tend to go into the user's phone.

How does the Product Solve it?

It doesn't solve the user losing the user's phone are stop people looking through the user's phone when the user's not pleasant. But if someone has got the user's phone and trying to log into it and with fingerprint security the phone won't give it access to the user's phone.

If they attempt to access multiple times it will take a screenshot and the picture will be up loaded to the Blueinfiniti platform and you'll be able check who it was trying to access the user's phone and has the user's phone if it was stolen.

How it Works
1. Stolen Phone
2. People access it
3. Takes a screenshot
4. Picture is upload without them knowing
5. Uploads onto Blueinfiniti platform
6. Power is the user's hands

### Deposit Checks

### Explain the Problem

Receiving cheque from work, business cheques, selling products, contractor jobs, the user have to travel to the ATM are the bank to deposit it, take time out of the user's day to do this process.

How does the Product Solve it?

With the Blueinfiniti platform the user will all the user's cards will be on one platform so the user will be able to deposit the user's cheque through our platform. When the user uploads the user's cheque the user will have the option to deposit it into a certain account the user would like. Pay pays, clear debt, savings, are be able to transfer the money to a friend, love one, are an employee. Are the user can divide the money into separate accounts.

How it Works
1. Open app with fingerprint, eye unlock are password and select deposit checks
2. Sign back of check
3. Take a picture of the user's check front and back.
4. Select which banking account the user wishes to deposit the check into.
5. Confirm the user's details and tap make deposit.
6. Confirmation alert on the Blueinfiniti.
7. Mistake made easy move the check from one account to another
8. Split the money into multiple accounts.

### Blueinfiniti Saving Account

Blueinfiniti has a feature on the platform for saving that can be automated saving accounted for every customer. Automated system can save daily, weekly, monthly. The special feature there isn't any fees so our customers and save and don't expect to spend more but save it. And with the Blueinfiniti debit card the user can spend the user's saving through our card without expecting fees. With the Blueinfiniti saving account the interest the user earn on savings accounts can be compounded daily or monthly rates will vary among financial institutions. We require a small amount of capital so we can offer interest rate to help the user grow the user's money without fees. If the user has multiple accounts the user can take money out any account for saving. And add it to Blueinfiniti saving account.
1. Set up daily, weekly, or monthly-automated transfers from whichever card the user prepare from the user's multi cards on the user's Blueinfiniti platform to the user's Blueinfiniti savings.
2. The user can set goals on the user's Blueinfiniti platform and when the user reach the user's goal we will be able to send the user a text alert when the user have reach the user's target and the user will be able to watch the user's saving grow with ease.
3. The user can save as much as the user want knowing there will be no fees to worry about
4. The user can pause the user's automated payment service if the user's short of money for the month
5. The user can transfer money from the user's savings to any of the user's card checking accounts the user desire.
6. Save as much as the user want
7. THERE WILL BE NO HIDDEN CHARGES NO FEES FOR SAVING THE USER'S MONEY WITH BLUEINFINITI

### Blueinfiniti Pay

On the Blueinfiniti pay system the user can upload money from a number of cards for paying at merchants, restaurants. The user can check the user's balance on Blueinfiniti pay and you'll be able to add funds whenever the user chooses it. So, the user won't have the hassle of picking which card to use.

How it Works
1. Add funds to Blueinfiniti Pay from a number of cards.
2. Check balances
3. Near field communication [NFC] chip embedded in the smartphones.
4. Hold the user's device near a card reader as the user would contactless debit card.
5. The user can use Blueinfiniti Pay to Make single purchase are multiple purchases on a daily basis.
6. Set the user's own amount of funds to spend a day are unlimited spending.
7. Customers pay no fees when paying with Blueinfiniti
8. Customers can return items and Blueinfiniti will refund their shipping costs up to $25 Dollars

### Blueinfiniti Protection Covers for Merchants

### Smooth Security for Sellers

### We Cover You.

With fingerprint security even eye unlock system you're totally covered when logging I, no need for card details or card numbers, we add an excellent layer of protection for the user's financial information.

### Merchant Prevention of Fraud

We have a 24/7 hotline that when the user's employees come across fraudulent activity are anything suspicious, we are here to help so we can help prevent and sort out the fraudulent transactions. We won't ever ask for the user's sensitive information I an email.

### Secure Technology

We have partnered with some of the world most trusted security companies in the world to save guard the user's information from to finish so the user can leave to worry to us and trust the user are secure.

### Monitoring 24/7

24 hours a day we are monitoring every transaction so even if the user slip up Blueinfiniti watches the user's back.

### When Problems Come Up

When there is a dispute with a transaction all funds will be held until the issue is resolved. We will fully commit is taking action in fixing any issue that comes up.

### Two Types of Buyers Claims

We Blueinfiniti understand is that is very important that security is essential for our customers and our business customers that will leaves them with a sense of relief that have an internet business, so we created a system to help safeguard anybody from losing money to claims and chargebacks.

### Unauthorized Transaction

There has been a transaction made and the buyer claims that he or she didn't make the payment

### Items not Delivered

Customers claim they purchased a product and never receive it

All these complaints can affect the user's balance on Blueinfiniti. But if our customers meet our requirements the user's balance won't be affected and remain the same because we want the user's transactions to be safe, accurate and secure. With that worry out of the road the user can move on with the user's business with Blueinfiniti covering all angles to keep the user protected.

### Secure Protection of Transactions

As protection we will cover digital item and physical products that are sold from merchants and online digital products. That are sold and shipped globally that there is proven that their businesses that are legit and have proven excellent businesses records. To create a secure protected system and you're totally protected items will be shipped within seven days of orders to the address that is indicated on the order and they provide an accurate delivery date. All details of the items will be upfront and honest about their products if they have defects, used and in good order. In order for digital product to be protected by Blueinfiniti the digital companies must provide a clear-cut company policy that there companies are legit. Before we will cover the digital products.

### Initial Requirement of the Protection of Merchants

1. Shipping address on the transaction page
2. The item must be in excellent physical condition that can be shipped even when selling digital items full record of the digital company must correct be selling for a number of years and have a good track record. If the digitals companies don't comply with are standards Blueinfiniti won't comply
3. When we request documents, are relevant information from either the merchant are digital companies they will have to respond within 7 business days.
4. The user's permanent address in whichever country you're in, we will request two form of information if requested.

### Further Requirements Needed

Items and Digital Product that have not Received
1. The items and digital product must be marked eligible on the transaction page
2. Tracking must be applied to all products for the protection of the items.

### Unauthorized Payment Cases

1. The payment on the page must be marked eligible on the transaction page.
2. Delivery and proof of shipment must be provided.

### What's not Covered by Blueinfiniti Protection

The majority of Blueinfiniti transactions are covered under the Blueinfiniti protection codes as long they follow our requirements we set out. However, there are certain things we won't cover and doesn't apply.
1. Products that are different as it was described as new and but sent a used product, claims, charges.
2. Products that are picked up in person are locally collected
3. Claims made from purchasing through eBay
4. Illegal substance like drugs, firearms, knives, and any counterfeit goods

### Proof of Delivery

Delivery of goods is an online document from the shipping company that states the following information.
1. The status of the item delivered
2. The date of arrival of the product
3. The customers address, state, city, postal area code
4. International postal requirements
5. The shipping receipt must match the billing address
6. Signature are scanned at the delivery address with a picture as proof
7. When scanned and photo taken will automatically upload to Blueinfiniti platform and message alert will alert the buyer and the seller that the product has been delivered.

### Shipment Proof

1. The shipping companies
2. The date, time of the products shipment
3. The customer's shipment address, city, state town of delivery
4. The shipment address and the billing address must match
5. All details can be track on the Blueinfiniti platform
6. Messaging between seller and customer through Blueinfiniti platform.

### Merchants can to do Ahead of Time to be Covered by Blueinfiniti Protection

1. If all details are satisfying, there is no need to do anything to sign up beforehand for coverage.
2. The date the item has been shipped
3. The customer's address, city, state, country, and the zip code. Address and billing address must match.
4. If any information is incorrect, please note the user is responsible for lose are any problems that can occur. Caution and care are needed, and the user's orders must be reviewed before any items have been shipped, and any fraudulent activity.

### When a Customer Files a Claim, What can Blueinfiniti Protection do

First of all, log into the user's Blueinfiniti account to see if the transaction was eligible. If we can't cover the user for the transaction, contracting the Blueinfiniti help center we can help the user through the process.

### Check Balances, Account Activity

### Explain the Problem

Having so many bank accounts, credit cards and so my many banking apps takes time to go through each platform to adjust, look and keep track of the user's statements, funds and spending, which bills coming out of which account.

### How My Product Solve it

With the Blueinfiniti platform the user will be able to go through all the user's account without leaving one platform. All the user's cards will be on one platform, and the user can access each card and view whatever the user want. Check everything what is coming in and going out of each account. Change payment options, change accounts for bills, choose main card for paying for purchases.

Just like the banks and credit card statements the user can review the user's mini statements on the Blueinfiniti platform.

Select each card to view the user's balances and look at the user's account activity.

Optional Uploading Driving License For hiring a car are general identification the user can upload the user's driving license

### Benefits of Blueinfiniti

1. No more ringing up banks and credit card companies to cancel the user's cards
2. No long phone calls trying to get to a customer representative
3. No more ringing up multiple banks and credit card companies
4. Fast effective system
5. High security
6. Safer payment system
7. Fastest Payment system
8. Email confirmation
9. Fingerprint security
10. Eye Recognition
11. No more ringing up credit card companies to activate the user's card
12. Time efficiently
13. Easy to use platform
14. Safes money for banks and credit card companies
15. Decreases fraud
16. Cyber security
17. Leaves customers with a sense of relief
18. Customer convenience
19. Faster way of doing banking

### Benefits

Blueinfiniti will uses the latest anti-fraud data encryption technology to maintain and protect the user's important information and keep safe and secure and reduced the risk of fraud to all our customers.

We will partner with top cyber-security companies to main top-class and anti-fraud protection.

With the Blueinfiniti our apps will be available on IOS, Android and all window devices, you'll be able to do all the features that Blueinfiniti will provide on all devices to the user's conveniences.

For buying and payments, our customers can register as many cards onto our platform and keep them all secure and locked, so they won't be scanned and illegal activity on their accounts. When buying products online the user chooses the product and select Blueinfiniti platform the product will be transferred to our platform and one more click for payment, all the user's shipping details will be in the user's profile so it's easy and fast.

### Features

1. Cancel and reorder
2. Phone to Phone
3. Cloud payment
4. 3 click payment
5. Travel notification multi cities and countries
6. Activate the user's credit card online
7. Finger print security
8. Eye scanner
9. High Security procedure are cloud payment
10. Multiple cards on one system
11. Easy to use platform
12. Coupons from discount and points from credit cards and have a system that redirects the points that can be used to get discounts
13. Text message after paying for things.
14. End of day spending
15. Weekly spending
16. Yearly spent all calculated
17. Organize payment for taxes
18. Spending budgets
19. State to state payment
20. Travel funds
21. Text messages alerts
22. Banks having a phone payment system if their customers don't have the user's phone as payment option have a payment feature that allows their customers pay for good if they lose their details.
23. Barcode on Blueinfiniti cards
24. Clip in cards for GPS
25. Barcode on cards
26. State to state payment
27. International pay
28. Buying Vacation online
29. Lock cards
30. Quick pay bills
31. Mile tracker
32. Tax organization
33. Manage budging
34. Passport unloaded
35. Screenshot intruders
36. Deposit cheques
37. Blueinfiniti pay
38. Blueinfiniti save
39. Check balances
40. Mini statements

Key features of the present invention include main store hubs, barcode stripes, aisle hubs, Blueinfiniti ATM, booking services, restaurants/bars, vehicle notifications, voice commands (Ok Blue), discount sharing, shopping lists, hotel booking, scanning items and preset customer age.

BlueInfinitiHub is a platform through which our members (stores, shopping malls, gas stations, and many others), are able to connect to their customers and access the numerous benefits that BlueInfiniti offers, making it the ultimate hub for customer engagement. Here is how it works: When a BlueInfiniti customer enters an establishment registered in BlueInfiniti, both will be notified about the match, enabling a mechanism that will make every commercial transaction that takes place between customer and establishment easier and faster.

For a BlueInfiniti customer, every time that they walk into a store associated with BlueInfiniti, every item that is shelved at the store will have a BlueInfiniti barcode. Because of this barcode and the BlueInfiniti scanner, when a customer walks out of the store, all of the products that the customer is carrying will be automatically charged to the customer's preferred debit/credit card, which are already registered with BlueInfiniti. This automated process eliminates the need for the client to go to the cashier, because the checkout is automatically done through the app. The clients receive an automated receipt as a notification and confirmation of their purchase.

### BlueInfiniti Aisle Hub

Through our collaborative strategy with large department stores and retailers, when a BlueInfiniti customer enters a store of let's say, The Home Depot, the client will receive an alert that they have just connected to Home Depot's BlueInfiniti Hub. This will facilitate the subsequent process: As the customer is shopping, each aisle will have its own individual hub that will keep track of the customer's purchases as they move from aisle to aisle. This enables for tighter controls and speeds up the buying process. When the client is done shopping, all the client has to do is to click confirm on the shopping cart, and that will notify the BlueInfinitiHub that the client is ready to check-out. The checkout process will take place automatically as the client walks out the store with the acquired merchandise.

The steps work as follows:

1. Shop in whichever aisle
2. Connect to the BlueInfiniti Hubs in each aisle
3. Select item for purchase
4. The hub in each aisle will track each item and when the client leaves that aisle the item will upload to client's checkout and so on
5. When client confirms that shopping is done, the BlueInfiniti Main Hub will be notified, and an automated check-out will take place as the client exits the building.
How does the BlueInfiniti Aisle Hub Work?
1. BlueInfiniti Hub in stores/malls/shopping malls

### 2. BlueInfiniti App

3. Message alert that notifies user of the BlueInfiniti connection
4. BlueInfiniti Barcodes on each item
5. Select item/items
6. Walk out of the establishment
7. Automatically check out with the right card for the right purchase, as predefined by customer
What Forms of Payment does the BlueInfiniti Customer has?

When a customer enters a BlueInfiniti associated establishment, the customer has the choice to connect to the BlueInfinitiHub or just check out in person with the BlueInfiniti Payment Card.

### How do the BlueInfiniti Scanners Work?

If any customer decides that they want to check out the merchandise that they have acquired manually, BlueInfiniti offers the option of scanning each item before placing them away in the carrier bags. If, during the checkout process, the customer decides that some items are no longer needed and therefore that they should be removed from the shopping cart, the customer is able to do so. The BlueInfiniti algorithm will detect the replaced item automatically through the BlueInfiniti barcode.

### Complementing the Shopping Experience—the BlueInfiniti Algorithm

Thanks to BlueInfiniti proprietary technology, our in-house designed algorithm will be able to optimize significantly the customer's experience, while increasing value for the customer and at the same time enhancing the retailer's revenues. For example, when a BlueInfiniti customer scans a specific clothes item (i.e.: a pair of jeans), a picture of the jeans will come up with a suggestion of a top that matches those jeans, offering a discount for the customer if he or she decides to buy it.

The similar process applies to food purchases, for example, if a customer buys a piece of chicken and a specific sauce, our algorithm will select different ingredients that could be a good fit for the meal as complementary (i.e. a specific dessert or wine).

How does the BlueInfiniti Policy for Returning Items Work?

When returning items, all that the client needs to do is to bring the item back to the customer service desk, where the item will be scanned to verify that it effectively belongs to that store and will automatically trace the name of the person that bought the item through the BlueInfiniti Hub. Therefore, the participation on the BlueInfiniti hub leaves both ends satisfied with a solution while reducing the possibility of fraud.

The Steps: How does it work?

1. Pull out your phone
2. Scan items
3. Receive deals on other items that match the one scanned in the store. The items will come with a discount
4. View list of items in check out and total
5. Walk out of the store
6. Automatically check out
7. Receipt emission.

### BlueInfiniti Service Provider

An additional service offered by BlueInfiniti comes when a BlueInfiniti-registered customer has a need for a specific errand or service to be performed, for example: plumbing, electric repairs, and others. A customer can simply log into the BlueInfiniti hub, select the service that needs to be done, together with the timeframe in which it can be done, and a BlueInfiniti-registered service provider will come and perform the task as requested. All payment will take place automatically to the app, and therefore, no uncomfortable money exchange takes place. After the transaction ends, receipts for both parties are provided.

How does BlueInfiniti Service Provider Work?
1. Select the service provider required, considering the best deals, star rating, and time scale that suits both parties.
2. Client chooses which offer of service fits it's needs
3. Add to check out and request
4. Service Provider will connect to client's hub on arrival
5. Service Provider does their job
6. Leaves the premises and then checks out and the payment is taken
7. Receipt will be upload on both hubs
8. Optional star rating

### BlueInfiniti Hub for Restaurants/Bars

When a BlueInfiniti-registered customer walks into a restaurant, bar, or other leisure establishment that is part of the BlueInfiniti Hub, both parties will be notified that any transaction will take place through their BI hub. The establishment will be notified that a BI customer has arrived. This will enable the service personnel at the establishment to automatically know where the BlueInfiniti-affiliated customer is sitting, as well as any preferences that the customer might have, which will be stored in the platform from previous visits that the patron might have done to that particular establishment. When the waiter/waitress takes the order, it will automatically be uploaded to the BlueInfiniti platform. This will enable individual orders to take place, as even in large groups, each person orders through their BlueInfiniti hub, facilitating the emission of separate bills and eliminating the need for the restaurant to do extra work. Checkout takes place automatically through the app when the customer leaves the premises. The client will have, at this point, provided the restaurant/bar with a pre-set tip amount for its purchases.

How does BlueInfiniti Work for Bars and Restaurants?
1. The client enters the establishment: Bar/Restaurant
2. Notifications of arrival of customer are sent to the establishment
3. Client orders food with the waiter
4. If in a group, clients get separate bills at the end of the evening, unless a patron provided different specific instructions through the BI hub
5. When the client leaves the restaurant, the client automatically checks out and bill is paid through the BlueInfiniti Hub.
What Problem does BlueInfiniti Solves for Bars and Restaurants?

It eliminates the need to split bills and go through the difficult process of figuring out what was consumed by each patron, facilitating the efficient processing of large groups. Also, it helps restaurants and bars retain the loyalty of patrons by providing a better service and having its staff focused on delivering a top-notch, quality experience that is human-centric instead of focused on details which could be automated.

### The BlueInfiniti Automated Shopping List

Before a client goes shopping, the client can upload a shopping list to the BlueInfiniti Hub through the BlueInfiniti App. As the client makes its way to the store, BlueInfiniti will automatically look for the best prices and deals on the products that the client added to its shopping list, and will notify the customer that that specific store has deals or discounts on the product that the client needs to shop. It will also let the client know how many products of these are left on the shelves.

Similarly, BlueInfiniti will have an algorithm that keeps track of certain items that the client acquires the most. So, for example, if a client is a frequent buyer of milk, and has a pattern of buying milk every certain number of dates, the app will send the user a notification that he or she might be running low on milk. Together with this notification, the BlueInfiniti Hub will notify the user of where the cheapest purchase is (in this case for milk) and the distance to the store where that purchase can be made.

How does the BlueInfiniti Automated Shopping List Work?
1. Client uploads shopping list
2. BlueInfiniti will notify client about items on your list in your vicinity
3. It will keep track of frequently bought items and notify the client near the time when the algorithm predicts that a certain item might be required
4. BI Hub seeks out the best deals and informs the customer, together with the location of those deals

### What Problem is Solved Through the BlueInfiniti Automated Shopping List?

BlueInfiniti Automated Shopping List provides every customer at any given local town with a chance of shopping the same product for a better price. It also provides shoppers with a great deal of convenience, as it streamlines their shopping process and saves them time by automatically remembering them when they need to make a purchase and what they need to buy. It also reduces the time spent on research or “price-hunting”, as the BlueInfiniti algorithm automatically can provide with tailored solutions for the customer's needs.

### BlueInfiniti ATM

The BlueInfiniti ATM algorithm is a program that will be installed at all ATM branches across the United States of America. This will be installed so that when BlueInfiniti customers who are using a BlueInfiniti Payment Card insert the card into the ATM, the screen will show all their accounts that they have introduced into the BlueInfiniti platform. Then, through their BlueInfiniti Card, they will be able to withdraw from any bank they choose. To prevent fraud, BlueInfiniti will limit the amount of money that comes out in one transaction. As an additional feature, a BlueInfiniti user will be able to set, through the app, a predetermined amount that the user wants to withdraw from the ATM, and therefore, when the card is inserted into the ATM, the ATM will only dispose that amount from the account previously indicated by the user.

How does the BlueInfiniti ATM Work?
1. A BlueInfiniti ATM algorithm will be installed into every ATM
2. The user inserts the Blueinfiniti card into the machine
3. All the user's banks will appear on the screen
4. User selects which bank the withdrawal will be made of.
5. User withdraws the money.
6. All money will come at once at the end of the transaction.
7. Optional bank transactions
8. User can setup up predetermined large amounts of money to be withdrawn on through the BlueInfiniti App
9. When the selected amount is chosen BlueInfiniti will send the user a notification to confirm the amount is right and that it has been previously authorized.

### What Problems are Solved Through the BlueInfiniti ATM?

The BlueInfiniti ATM solves numerous problems that often take place during financial transactions, primarily, the unreliability of several ATMs as they depend on the rules of each individual bank. The BlueInfiniti ATM Hub will make that process uniform and reliable. Also, it will provide the user with several choices that they do not have under the current way of ATM operation, for example: Allowing the user to do multiple transactions from a different number of banks, all at once, as well as showing all bank balances on one single screen, and finally, allowing the user to set up a predetermined withdrawal amount that can reduce the risk of fraud, eliminate the risk of unauthorized withdrawals in the case of card theft, and ensure that the user has as much money as needed in case a large withdrawal is required.

### BlueInfiniti—Barcodes on Items

Through our process, every item that is present at a grocery store or retailer at any shopping mall will have a BlueInfiniti barcode that links the item to the BlueInfiniti Hub. This enables BlueInfiniti to notify the appropriate users every time that there is something for sale, and also, it enables the store to know the exact quantity of every item sold in real time, allowing decision makers to have precise information of how much of what has been sold has been on sale, and how much has been at the regular price. This allows stores to keep track of their inventory in real time. With the BlueInfiniti Hub Barcodes, stores will also know detailed information about every product and their expiry date, ensuring that the stores have proper notice about the said items so that they can remove them from the shelves.

### How do the BlueInfiniti Barcodes Work?

1. Barcodes on every item
2. BlueInfiniti Hub connects with every item
3. BlueInfiniti Hub connects to customer
4. Blueinfiniti hub knows which item and how many items customers have.
5. Keeps inventory automatically which the item checks out
6. Keeps track of food with an expiry date.
7. Customers walk out of store and they will automatically check out.

### BlueInfinitiHub—Menu Search Option

As a part of the services offered through the back-office of the BlueInfiniti platform, the company will provide the user with a search engine that will provide the customer with multiple stores and service providers that offer discounts and deals close to their current location, enabling the BlueInfiniti customers to save money. Every merchant that is part of the BlueInfiniti Hub can load up their offerings to connect with their prospective clientele through discounts and services.

A practical example of this application would be if a BlueInfiniti customer is looking for a trustworthy and reputable dentist. The customer would log into the BlueInfiniti Hub and look for a dentist. Then, the dentist will load up their schedule on a daily basis including their rates. From this shared schedule, the customer can schedule an appointment with the dentist based on the previously stated availability. A BlueInfiniti Hub will be installed at the dentist office, and when the customer enters the property and connects to its BlueInfiniti Hub, all the treatments and procedures that the customer undergoes during the visit will be uploaded to the back-office system of BlueInfiniti, so that future treatments or plans can be personalized according to the patient's needs. Also, this will automate the payment process of the patient for the different sessions or procedures required for treatment, and once the patient is finished with every treatment, they simply walk out of the clinic and the BlueInfiniti Hub will automatically check the customer out.

Another application of the BlueInfiniti Search Menu comes when looking for bars and restaurants. When the client is looking for a bar or a restaurant, the customer can do so through the BlueInfinitiHub and proceed to book a table at the preferred date and time and can even proceed to order a drink and appetizers before he or she arrives. As soon as the customer enters the establishment, the BlueInfiniti Hub will connect the restaurant with the customer and notify the appropriate staff of the customer's arrival and proceed to serve the drink or appetizer that the customer will have ordered, accelerating the speed of the pertinent service.

How does the BlueInfiniti Search Menu Work?
1. The customer searches for a particular product or service and sees the different deals and discounts that are available
2. The customer selects a service that matches their need
3. The appointment at the preferred location is booked through BlueInfiniti
4. BlueInfiniti connects the customer with the establishment upon arrival, notifying the establishment
5. Service is provided
6. Financial transaction takes place through the BlueInfiniti Hub
7. In the case of appointments that require follow-up, information will be uploaded to BlueInfiniti for faster processing
8. Reminders and notifications will take place for upcoming appointments or reservations.
What Problem does the BlueInfiniti Search Menu Solves?

The BlueInfiniti Search Menu provides the customer with a faster alternative to search for different services, places, or products that he or she might require, customizing and focalizing the search in the customer's local vicinity rather than expanding it to a global search as other more generic search engines do. The BlueInfiniti Hub also takes into consideration other filters that the customer might provide to our algorithm such as budget, distance, and many others.

### BlueInfiniti for Hotels

Through the BlueInfiniti Hub, customers will also be able to book hotel rooms without leaving the app. Whenever a customer books a hotel room through the BlueInfiniti App with a BlueInfiniti-member hotel, the hotel will receive a notification when a customer arrives. The BlueInfiniti Hub will automate the check-in process and will send the customer with the details of the room number. Also, the hub will provide the customer with an electronic access key for the room, so that the customer is able to enter the room with his or her phone instead of using a physical key. Another advantage of the mobile, electronic room key is that it also allows the customer to walk through the security doors that the hotel might have set in place before entering the room area. When the customer's stay is over, the customer simply walks out of the hotel and the checkout process takes place automatically.

How does BlueInfiniti Work for Hotels?
1. The customer books a room through the BlueInfiniti Hub
2. The customer walks into the hotel
3. As the customer walks in, customer is connected to the BlueInfiniti Hub
4. Check-in process takes place automatically, and the customer receives an electronic access key
5. Customer uses electronic access key in phone for access to the room and security doors
6. Customer leaves the hotel. Checkout process takes place automatically.
What Problem does the BlueInfiniti Hub Solve for Hotels?

By implementing the BlueInfiniti platform and joining the BI Hub, the hotel will experience a significant reduction of check in or customer support related queues, as well as experience a considerable streamlining of the payment process. It will also free up the hotel staff to focus on things that enhance and improve the customer experience, instead of dealing with repetitive tasks that can be automated such as check in, check out, and payment-related processes.

### BlueInfiniti Car Notifications

The BlueInfiniti Hub will also provide its users with significant benefits and services when driving. One of them will take place when the warning sign lights up in the customer vehicle, the BlueInfiniti hub will automatically detect the problem and send the customer options of the best place to get a vehicle checked and repaired, as well as list the discounts that the repair shop offers and what their availability is. BlueInfiniti will speak to the customer through the vehicle's speakers and will allow the customer to connect with that particular service provider and book an appointment. When the customer books an appointment, BlueInfiniti will automatically notify the repair shop of the arrival of a customer for a checkup or repair. As with all of our features, this one provides customer and store with an automated check out to eliminate the need for cash to exchange hands.

### How do the BlueInfiniti Car Notifications Work?

1. When a warning light comes up at the car, BlueInfiniti notifies the customer
2. BlueInfiniti offers the customer locations of repair shops and mechanics in the vicinity, including discounts and best prices.
3. The voice command of BlueInfiniti will take place over the car speakers and enable the user to make an appointment.
4. BlueInfiniti checks customer in at the chosen repair shop or service provided.
5. Car is fixed.
6. Automated checkout.
7. Receipt will upload in the back office of the BlueInfiniti app.

### What Problem is Solved Through BlueInfiniti for Car Owners?

The BlueInfiniti Hub provides car owners with prompt notifications about problems that are going on with their vehicle. It also eliminates the need for the customer to research and investigate repair shops, which is very diligent and time consuming. As a result, BlueInfiniti automatically provides the customer with options where the car can be fixed and accelerates the process of a vehicle repair, reducing the risk of an accident or further problems due to the unhealthy vehicles that are circulating the streets.

### BlueInfiniti Voice Control (Ok Blue)

One of the most innovative features that conforms a key part of the BlueInfiniti Hub is the BlueInfiniti Voice Control, also nicknamed OkBlue. The voice control feature of BlueInfiniti will enable the customer to speak to the BlueInfiniti app. The customer can simply enter a voice command, beginning with the words OkBlue, for example: “OkBlue, is there anything in my shopping list that I need before I go?” And then, the BlueInfiniti App will read out loud potential items that the customer might require by gathering data from your shopping list and your most recent purchases. The customer can also say: “OkBlue, are there any discounts around me at this minute?” and the BlueInfiniti Hub will automatically look for discounts in the area where the customer is currently located. These examples can vary and may be filtered, for example:

“McDonald's is having a Buy One, Get One Burger Free promotion”
“X local pub is having an extended happy hour”
“Gucci is having a 50% discount today”

Once the customer listens to the different options available, the customer can say, “OkBlue, take me there,” and the satellite navigation system will activate on the car and automatically reroute the navigation to the destination where the discount is taking place. The BlueInfiniti Hub will provide user with notifications related to the chosen discount when pertinent and in case any updated information is received. It will also enable the user to share this discount with friends and family.

How does OkBlue Work?
1. Customer starts every sentence with “OkBlue”
2. Client mentions voice command
3. OkBlue runs specified command
4. If command matches customer interest, customer instructs OkBlue to take him or her to the destination of interest
5. OkBlue activates the car navigation system and reroutes the navigation to the place of interest.
What Problem does it Solve?

By enabling voice control, BlueInfiniti prevents the client from actively looking at his or her phone while driving. By activating everything through the voice mechanism, BlueInfiniti effectively reduces the risk of car accidents while also increasing convenience for the user.

### BlueInfiniti Hub—Optional Discount Sharing

Through the discount sharing features, a BlueInfiniti member can share discounts with friends and family. The discounts are shared through the app, and when the recipient accepts the discount and arrives at the establishment that is offering it, the BlueInfiniti Hub will automatically notify the recipient that a discount will be applied to their purchase.

How does it Work?
1. Customer receives discounts through a search in the BlueInfiniti Hub
2. The customer shares the discount with friends and family through the BlueInfiniti Hub
3. The customer sends a voice command to OkBlue to share the discount with friends or family
4. The recipient receives the discount and can activate it through their BlueInfiniti

Hub

BlueInfiniti Hub—Searching for Products

In order to enable a more convenient way of shopping, the customer can go to the search engine located in the BlueInfiniti Hub and type in any item or service that might be required. As the product is typed in, the BlueInfiniti Hub will show the customer the stores that are offering that product, as well as their prices, the distance that the store is located at from the customer's current standpoint, as well as any other discounts that might be offered for the item that is being searched for. Any product from a store that is a member of BlueInfiniti can be pre-ordered for pickup, and when the customer walks into the store, the store will have the product ready for pick up as BlueInfiniti will notify the store that the customer has arrived to pick it up. An automated checkout process will take place.

How does it work?

1. Customer pulls up the search engine
2. Customer inputs item or product that is being looked for
3. Options come on the screen
4. Customer chooses location of item
5. BlueInfiniti store will be notified of a pickup
6. Customer picks up the item
7. Customer walks out with the item
8. Automated checkout

### Can the Hub be Switched on and Off?

The customer can choose, at any moment, to switch off the automated payment system and just pay with a BlueInfiniti Card. It can also switch off notifications in order to enjoy a moment of peace and tranquility.

### Signing Up for BlueInfiniti

When a customer is looking to sign up as a member at the BlueInfiniti Hub, the customer will be required to fill an online form, which will confirm that the customer is older than twenty-one years, primarily to prevent unauthorized consumption of items such as alcohol or tobacco. BlueInfiniti members that are younger than twenty-one years will not be allowed to make this purchase, and because their age will be registered in the platform, every store that they walk into will be notified of their underage condition to prevent them from buying those products.

### BlueInfiniti for Gym Customers

BlueInfiniti works with every gym and fitness establishment in the United States to help them provide a better service. How does it achieve it? For example, if a customer is living in San Rafael, Calif., and is a regular user of a certain gym, but then finds itself traveling, the BlueInfiniti App will enable the customer to work out at any gym in any city or town that he or she might be visiting as a pay-as-you-go customer, and still keep his or her monthly subscription to his or her regular gym. BlueInfiniti will provide the user, when traveling, with specific gym recommendations and will facilitate a smooth, online check-in process, as well as notifying the gym at the new location that a BlueInfiniti customer has arrived. Payment for the day will take place through the BlueInfiniti App.

How does it Work?
1. BlueInfiniti Hub provides user with a database of gyms in the vicinity of the customer
2. Customer chooses preferred gym to workout
3. BlueInfiniti notifies the gym of a new customer's arrival and facilitates speedy sign-in
4. Customer works out at the gym
5. Customer finishes work out and leaves
6. Check out takes place automatically through the BlueInfiniti App

### Happy Hour Promotions Through BlueInfiniti

Any BlueInfiniti customer will receive exclusive promotions and offers at their preferred places. After a specific number of visits to be determined by each particular location, the BlueInfiniti Hub will notify an establishment of a customer's loyalty, and after that visit has taken place, the establishment will offer the customer a happy hour deal regardless of the day of the week or time of the day. All orders can be made through the BlueInfiniti App. Also, BlueInfiniti keeps customer's preferences in sight so that whenever the customer visits the establishment again, the customer's favorite drink and snacks will be remembered for a prompt and facilitated order.

How does it Work?
1. Customer walks into preferred establishment and connects to BlueInfiniti Hub
2. Customer receives notification of discount or deal being offered
3. If customer decides to accept the offer, the order is submitted through the BlueInfiniti Hub
4. Order is confirmed
5. Order is served
What Problem does it Solve?

It reduces waiting times both for the patrons and for the establishment. It also enhances loyalty and customer's preference for a particular place and rewards that loyalty with promotions and savings.

### BlueInfiniti Business Card

For companies and business operations, BlueInfiniti offers the BlueInfiniti Business Card, in order to facilitate the company's financial transactions. This is an example: A contractor of a busy construction site might have multiple credit cards, and in order to reduce bureaucracy inside the organization, the contractor would need to apply for cards in behalf of multiple staff members and superintendents. With BlueInfiniti, the card will enable employees to pay for materials with their own BlueInfiniti Card and check out on behalf of their company. The company will be notified of the purchase to ensure compliance and prevent unauthorized purchases.

This also reduces the amount of internal processes needed for employee travel for business purposes. For example, when an employee attends a company-related trip, the employee can use the company's BlueInfiniti Business Card and pay through their BlueInfiniti Hub.

In case of a termination of contract or end of the employee's role with the company, BlueInfiniti will automatically disable the account and disconnect the employee from the company's payment system. This enables for tighter controls and reduced bureaucracy on the company's back end.

What Problem does the BlueInfiniti Business Card Solve?

It reduces internal bureaucracy and eliminates the need for companies to apply for credit cards on behalf of employees. It also streamlines the expensing process for employees and implements tighter controls on company's expenditures on business traveling, reducing costs and time spent in verifications and internal audits. It also eliminates the anxiety-ridden waiting times when employees are waiting for employers to reimburse their expenses.

### BlueInfiniti Hub—Sporting and Entertainment Events

Facilitating payments at sporting and entertainment events is another area of expertise at BlueInfiniti.

When a BlueInfiniti customer attends a sporting event or an entertainment & leisure happening, such as a musical or a concert, they can connect to the venue's BlueInfinitiHub, which automatically houses all the vendor's individual BlueInfiniti connections. When a customer decides to order a drink or a meal at the event, they can do so through the BlueInfiniti App and have a concession server deliver it to their seat. Check out is automated through the platform.

How does BlueInfiniti Work at Sporting and Entertainment Events?
1. Customer enters venue and connects to the venue BlueInfiniti Hub
2. The venue's BI Hub houses each vendor's individual BI Hubs
3. Customer orders through BlueInfiniti App
4. Stadium hub picks up the order and sends it to the concession
5. Concession server delivers whatever was ordered to the customer's seat
What Problem does BlueInfiniti Solves for Sporting and Entertainment Events?

It provides customer with a speedier alternative for payments, ordering, and consuming while avoiding the maddening crowds. It also provides vendors with a more organized way to enhance their operations, and simultaneously, it streamlines their inventory process and sales records.

Although the invention has been explained in relation to its preferred embodiment, it is to be understood that many other possible modifications and variations can be made without departing from the spirit and scope of the invention.

### Blueinfiniti ATM

Blueinfiniti touchless ATM machine is ATM that is controlled using your mobile phone, without physical touch to the current ATM. When you approach the ATM you scan your mobile over the contactless technology called (NFC) Near field Communication and Radio frequency. That contacts your phone to the ATM. For security and privacy of our customers and personal information the ATM with send a secure passcode for our customers to enter into their phone to access the finger print security options. They use their finger print security to access their accounts, on the screen of their phones. On the screen of their phones they will be able operate them same functions as on the screen of the ATM, and conduct whichever their needs are. Example 24-hour access to cash, deposit cheques, view account balances, and mini statements, transfer funds, pay utility bills. When you are just looking to withdraw cash you simply select your amount you require click confirm and use your fingerprint on the screen of your phone to make the transaction, for the blueinfiniti ATM to issue the money. Once the transaction is complete you simply log out through your phone. And the transaction is complete. A text message will be sent to your phone with information indicating, amount, date, time, and location. On blueinfiniti ATM there'll be camera recording while our customers are doing their transactions, the camera will record anybody that is be suspicious standing behind our customers. Example people watching over our customers while conducting a transaction and for pick pockets. Our camera will hold the video surveillance for 48 hours so if something went wrong the coverage can be used for police investigations.

### How it Work

1. No physical touch to Blueinfiniti ATM Machine
2. Scan mobile phone over the NFC reader to access account
3. Blueinfiniti ATM sends passcode to your mobile to confirm activation
4. Activate your account through finger print security on your phone
5. All functions will be operated through a mobile device
6. Withdraw cash from your phone. Select amount from the screen of your phone, click confirm and the money will be released from the Blueinfiniti ATM
7. If in doubt you get distracted and don't collect your money in time the Blueinfiniti ATM will beep
8. Collect your money from the machine and log out through your phone.
9. Stops the spread of the coronavirus
10. No more touching dirty ATM machines

### What is Will Resolve

With the original ATMs, they can dispense too much money, too little money. Fails to give receipts and swallows bank cards.

ATM skimming of theft of customers cards, known as a skimmer that are installed onto the original ATM. And it can skim during a legitimate ATM transaction. Even when your card is swiped at the machine, the skimmer device captures the information stored on the cards magnetic strip.

People watch over you while you input your four-digit pin.

Freelance ATM can be hack by scammers through Wi-Fi and cracking programs to download transaction data when the systems fail to protect by high level encryption software.

Frequently the ATM'S make error by depositing large amount of money by mistake into people's accounts.

Frequently used ATM is 40% and average person uses an ATM 8-10 times a month. Popular area where the ATM is located where there is large amount of people are used 60% on a daily basis.

With a large amount of people using an ATM'S on a daily basis there is a highly dirty and with cross contamination on the keypad. And now with the outbreak of the coronavirus around the world now people and customers in the banking world will be cautious using the original ATMS is one way to spread the virus by using the keyboard and the screens of the ATMS.

### Blueinfiniti Over the Phone Payments

When you want to purchase items from a merchant over the phone. The merchants will have the Blueinfiniti platform for accepting payments. When you speak over the phone to the merchant the Blueinfiniti platform will capture your voice through voice recognition. The blueinfiniti platform will send a passcode to the customer's phone for confirmation. When the customers confirm the passcode, the customers blueinfiniti account will be contacted to the businesses blueinfiniti platform. You order your items with the merchant and he/she inputs the details on the to blueinfiniti platform. When the customer is finished her requests, the merchant sends all the items to the customers phone and the customer confirms the items and prices on the screen of the his/her phone. When the customer is happy and wants to proceed with the shopping she clicks confirm on the phone and uses the fingerprint payment option to complete the transaction. The payment will go to the blueinfiniti platform in the business for confirmation. When the confirm the payment has went through there will be a receipt forward to the customers blueinfiniti app.

### How it Works

1. Ring merchants
2. Merchant and customer use blueinfiniti
3. When you ring the business you require items/products from the blueinfiniti platform in the store will recognizes your voice.
4. The blueinfiniti platform will send code
5. Input passcode for security for connection between the customer and merchant
6. Order items and the cashier inputs your items onto the blueinfiniti platform or check out
7. When finish the cashier forwards on the items to your phone for checkout
8. View and use finger print security to pay
9. The request will go to the merchants and wait for confirmation
10. An receipt will be sent to the customers blueinfiniti app
   What does it Resolve?
1. Ring up with no card
2. People can't take your card details
3. No fraud can take place
4. Faster way to pay saves time
5. Merchant doesn't have to type card details
6. Limits mistakes while entering while entering

### Restaurants and Bars

Restaurants and bars have to the blueinfiniti platforms. When a party of people come into a restaurants/bar each person will have an option connect to the blueinfiniti hub that is in the establishment. There will be an option alert on the phone to accept the connect between the blueinfiniti hub and the customers blueinfiniti hub.

### Example 1

One member of the party can take charge of the bill and connects to the blueinfiniti hub in the restaurant/bar. The waiter/waitress brings down the tablet for ordering food and drink, for everybody in the party under each name and the order goes onto the member that is in charge. When the night is over the member in charge asks everyone at the table to connect to his/her blueinfiniti Then he/she can transfer everybodys order separately for payment with the right orders to the right person.

Each member is connected to the restaurants blueinfiniti hub and when they checkout they use fingerprint to make the transaction. Text alerts will be sent from the restaurant's hub of confirmation and a receipt. And future promotions.

### Examples 2

When a party of people come into the restaurant/bar they can a message alert from the blueinfiniti hub. Each person connects the hub. When the waiter/waitress comes down to take the order, she has a tablet with each people name already uploaded for the order to be take. She individually places the order to each person separately and the order can be seen in their blueinfiniti app. When the night is over and there ready to checkout, they go onto the app to make the payment. Each person uses their print finger to complete the transaction. A message alert come to their phone for confirmation and receipt.

In case the people forget to pay and leave the blueinfiniti platform will keep alerting them to pay until they make the payment. And if in case they don't make the payment the blueinfiniti will cover the price and blueinfiniti will take action until the payment is received. If failure of payment blueinfiniti will lock their account until the payments is made.

### How it Works

### Example 1

1. Connect to restaurant/bar blueinfiniti hub
2. Waitress/waiter uploads the order to the main person of the party
3. Order is taken by tablet and is up load to the blueinfiniti hub
4. When night is over the main person connects to everybody at the party
5. He swipes the correct orders to each person
6. Each person pays by finger print security
7. Email alert comes through that the transaction was successful

### Example 2

1. Each person contacts to the blueinfiniti hub at the restaurant
2. Waiter/waitress has the tablet with each person on it
3. Each person orders in their own name and inputted by the waitress/waiter
4. The order goes on the customers blueinfiniti app for viewing
5. When the nights over each person checks out by using finger print security
6. Email alert comes through with the confirmation
7. People don't pay they will get a continuous alert until the bill is paid
8. Unsuccessful customer will be blocked are will not be able to use the platform and with warning for the future

### What it Resolve

Limits the amount of credit cards and debit cards use by multiple people at the party.

Limits the waiter and waitress with multiple different transactions with multiple different card and rec

The waitress/waiter can carry on with order things.

### Online Shopping

While shopping online our customers want to purchase items online. You simply hold onto the item and the product will enlarge in size with the logo blueinfiniti popping up for option to pay. When you click pay with blueinfiniti the finger print option will come up. You pay by finger print and the payment will go to blueinfiniti cloud pay, the money will leave the customers account. A notification will be sent to the seller that informing them that the payment has been taken, and for them to release the product. The online seller/company will release the product with a blueinfiniti tracking device. Once the postman scans the package at the address of the customer the payment will be released to the seller/company

### How it Works

1. Search through the internet for items
2. Select the item by holding it down it will enlarge
3. Finger pay option will come up
4. Payment will go to blueinfiniti cloud
5. Notification will be sent stating the money has been taking and waiting the release of the product
6. Product with be sent by the seller with blueinfiniti tracker
7. With scanned by mail man the money will be released to the seller
8. Message to the customer and the seller that the process is complete.
9. Receipts will be issued

### How it Resolves

1. No multiple pages for checking out your items
2. Fastest way to pay
3. All information on blueinfiniti app for viewing
4. No more third-party payment services
5. No redirecting to other sites
6. No information to put i.e. address etc it's on blueinfiniti
7. Blueinfiniti will redirect the information to company

### Paying for Items at Merchants/Food Take Away

While shopping for anything in merchants/shopping centres/petrol stations anywhere, that use debit card machine to purchase products. The person behind the check out will use blueinfiniti virtual payment terminals to scan items/products that the customers requires. The customers will scan their phone over the blueinfiniti NFC reader that will connect the customers blueinfiniti account to the shops blueinfiniti hub. When the connection is made the customer will use their fingerprint to confirm connection, the customer will be able to view their shopping list on their phone and when she/he is happy she clicks confirm and the transaction is over. With an email receipt sent to the back office of the blueinfiniti app.

### How it Works

1. Cashier scan items with blueinfiniti virtual payment terminals.
2. Customer scans phone over blueinfiniti NFC reader to make connection to the stores/shops blueinfiniti reader.
3. Customer uses fingerprint to make connection
4. When connection is made the customer can view the products/items on their phone
5. With blueinfiniti all cards will be on one platform and blueinfiniti will choose the right card for the right purchase, other options are that our customers can select one card for do all. Are have another options on the back end they'll able to spilt the payment between different cards
6. When check out is completed the customer clicks confirm on their phone and the transaction is completed
7. Email receipt will be sent to the back office of the blueinfiniti app
8. Thank for you message

### What it Resolves

1. No physical contacts with money, cards, debit cards, money.
2. No debit cards needed
3. High security
4. No skimming
5. Blueinfiniti will choose the right card for the right purchase are other multiple options the customer chooses for payment

### Blue Chat

### Example 1

While driving your vehicle an engine warning comes on, through the radio to ‘you say’ ok blue what is the warning light means. The on board blueinfiniti system it will speak to say the issues, example oil needs changed, car needs serviced. So the driver will ask blue chat for local garages for prices, dates and times for booking and to compare the places and the rate of the dealership are garages service. The blueinfiniti system will search for suitable place to go and will get your request with numerous locations. You choose the suitable location and it will book your car in. The driver will have an option to pay for the service with voice recognition are when they drop their car off they connect at the garage and use print finger print. The blueinfiniti car system will connect with the dealership/garage blueinfiniti hub to complete the request. All information of the car the issue will be sent forward in time so the dealer knows what is required for them to do.

### Example 2

Through blueinfiniti app you can talk to the app for whatever request you want, ie dentist appointments, hair appointments, booking restaurants, takeaways, hotels, flights, and so on. The blueinfiniti platform will search your local area and can set a mile radius for establishments. You ask to book through the platform will search through the web and get cheapest prices, dates and times that suit you and that there free, and it will input onto your screen for you to choose from. When you choose you can book through the app and using finger print pay (optional) are pay at the location and the request will be processed. All your details will be sent to the establishment (name, time, date, and location) and a remember message sent be sent on the day if changes happen you can cancel are click approve then a welcome message will be sent.

You walk into wherever you have chosen and on your blueinfiniti app will connect you with the blueinfiniti hub in the establishment. And you use the finger feature for payment.

### How it Works Example 1

1. Engine light could you request information for the blueinfiniti system
2. The blueinfiniti informs you of the issue
3. You request information from local garages
4. Your blueinfiniti app is connected to the car blueinfiniti system
5. Blueinfiniti searches the web through your blueinfiniti app are local garages
6. The blueinfiniti system finds prices, times and dates
7. You choose
8. Blueinfiniti books your appointment
9. The garage sends you message with all your detail's
10. Arrive at garage connect with the blueinfiniti hub, work gets completed, the garage sends the bill to your phone for payment and you use fingerprint to pay

### Example 2

1. Search web through blueinfiniti for whichever service you required
2. Blueinfiniti searches and gets dates, times, and establishments in your local area
3. The list will appear with suitable times and dates
4. You choose
5. Confirm
6. The establishment send message of the details
7. When entering the establishment the customers blueinfiniti app will connect with blueinfiniti hub in the establishment.
8. When your visit is over they send the bill to your phone and you pay by finger print
9. Receipt goes to the back office

### Blueinfiniti Currency App

When you have currency (dollars, euros, british pounds) that you need to exchange and the rate isn't good at the time you want to change them, and you want to wait for a good rate you simply deposit it into your bank account and add it to the blueinfiniti platform under the Currency platform. The customer will be able to set a suitable rate/price for the money to be exchanged to get the best value. And when the market has reached the rate that the customer has setup, blueinfiniti will send an alert stating the currency is at the rate they require. They log in and click confirm and the money will be transferred to the customers bank account.

### How it Works

1. Deposit the currency into bank
2. ADD TO BLUEINFINITI PLATFORM
3. SET SUITABLE RATE/PRICE
4. WHEN IT REACHES THE RATE/PRICE MESSAGE ALERT
5. LOG IN CLICK CONFIRM
6. MONEY DEPOSITS INTO YOUR BANK ACCOUNT
   What does it Solve

Keeping looking at the currency rate to increase. And gain more money while you don't have to keep a day to day watch on the market.

What is claimed is:

1. A method of managing a personal payment platform, the method comprises the steps of:
(A) providing at least one user account managed on at least one remote server, wherein the user account is associated with at least one user personal computing (PC) device, and wherein the user account is associated with a plurality of virtual credit cards managed by the remote server, and wherein each virtual credit card includes a card description, and wherein the user account is associated with a physical access card;
(B) relaying a payment request for the user account from the user PC device to the remote server, if the payment request is received through the user PC device, wherein the payment request includes a payment description;
(C) relaying the payment request from the physical access card to the remote server, if the payment request is received through the physical credit card;
(D) comparing the payment description to the card description for each virtual credit card with the remote server in order to identify a matching card from the plurality of virtual credit cards; and
(E) executing the payment request with the matching card through the remote server.

2. The method of managing a personal payment platform, the method as claimed in claim 1 comprises the steps of:
generating the plurality of virtual credit cards with the remote server during step (A) by scanning a plurality of physical credit cards into the user PC device;
prompting the user account to assign a default designation to a specific card from the plurality of virtual cards with the user PC device;
relaying a selection of the specific card from the user PC device to the remote server, if the default designation is assigned to the specific card by the user account; and
appending the default designation into the card description of the specific card with the remote server.

3. The method of managing a personal payment platform, the method as claimed in claim 1 comprises the steps of:
prompting the user account to replace the physical access card with a new physical access card with the user PC device;
relaying a replacement request for the new physical access card from the user PC device to the remote server; and
executing the replacement request for the new physical access card with the remote server.

4. The method of managing a personal payment platform, the method as claimed in claim 1 comprises the steps of:
providing the user PC device with a personal area network (PAN) module;
prompting the user account to enter a transfer amount with the user PC device;
prompting the user account to enter contact information for the transfer amount with the user PC device;
prompting the user account to select a specific card for the transfer amount with the user PC device, wherein the specific card is from the plurality of virtual cards;
relaying a transfer request from the PAN module to the contact information, if the transfer amount is entered by the user account, and if the contact information is entered by the user account, and if the specific card is selected by the user account;
relaying the transfer request from the user PC device to the remote server, if a confirmation for the transfer request is received from the contact information with the PAN module; and
executing the transfer request for the transfer amount between the specific card and the contact information for the specific card with the remote server.

5. The method of managing a personal payment platform, the method as claimed in claim 1 comprises the steps of:
providing a virtual vault managed by the remote server;
relaying a recipient payment for the payment request from the matching card to the virtual vault during step (E);
holding the recipient payment with the virtual vault, until the remote server receives a purchase delivery confirmation; and
releasing the recipient payment from the virtual vault, if the remote server receives the purchase delivery confirmation.

6. The method of managing a personal payment platform, the method as claimed in claim 1 comprises the steps of:
providing each virtual credit card with administrative contact information;
prompting the user account to enter a set of travel plans with the user PC device;
relaying the set of travel plans from the user PC device to the remote server;
compiling the set of travel plans into a user travel notification with the remote server; and
relaying the user travel notification from the remote server to the administrative contact information of each virtual credit card.

7. The method of managing a personal payment platform, the method as claimed in claim 1 comprises the steps of:
generating a new virtual credit card by scanning a new physical credit card with the user PC device, wherein the new virtual credit card includes a new administrative contact information;
relaying an activation request for the new physical credit card from the remote server to the new administrative contact information; and
appending the new virtual credit card into the plurality of virtual credit cards with the remote service, if an activation confirmation for the new physical credit card is received from the new administrative contact information with the remote server.

8. The method of managing a personal payment platform, the method as claimed in claim 1 comprises the steps of:
outputting a payment-made notification for the payment request with the user PC device after step (E);
prompting the user account to freeze the virtual credit cards with the user PC device; and
preventing future transactions with the virtual credit cards with the remote server, if the virtual credit cards are selected to be frozen by the user account.

9. The method of managing a personal payment platform, the method as claimed in claim 1 comprises the steps of:
executing a plurality of iterations for steps (B) through (E), wherein the payment request and the matching card for each iteration is recorded as a financial transaction by the remote server;
compiling the financial transaction for each iteration into a financial statement with the remote server; and
outputting the financial statement with the user PC device.

10. The method of managing a personal payment platform, the method as claimed in claim 1 comprises the steps of:
providing a plurality of financial services managed by the remote server;
prompting the user account to select a desired service from the plurality of financial services with the user PC device; and
executing the desired service through the remote server, if the desired service is selected by the user account.

11. The method of managing a personal payment platform, the method as claimed in claim 9, wherein the plurality of financial services includes a bookkeeping service, a tax calculation service, a business accounting service, a business travel-tracker service, a service for detecting fraudulent out-of-state transactions, an automated bill-paying service, a check depositing service, an automated savings service, a fraudulent-transactions management service, a fraudulent-transactions resolution service, a service for interacting with an automated teller machine, a service for managing/sharing discounts and promotions, and a service for distributing virtual business cards.

12. The method of managing a personal payment platform, the method as claimed in claim 1 comprises the steps of:
providing a plurality of travel services managed by the remote server;
prompting the user account to select a desired service from the plurality of travel services with the user PC device; and
executing the desired service through the remote server, if the desired service is selected by the user account.

13. The method of managing a personal payment platform, the method as claimed in claim 12, wherein the plurality of travel services includes a vacation purchasing service, a hotel booking service, a transportation hiring service, and a virtual passport storage service.

14. The method of managing a personal payment platform, the method as claimed in claim 1, wherein the physical access card is inscribed with a unique printed identifier, and wherein the unique printed identifier is encoded with contact information for the user account.

15. The method of managing a personal payment platform, the method as claimed in claim 1 comprises the steps of:
providing a location tracking module, wherein the location tracking module is integrated into the physical access card;
retrieving a current location of the physical access card from the location tracking module with the remote server; and
outputting the current location of physical access card with the user PC device.

16. The method of managing a personal payment platform, the method as claimed in claim 1 comprises the steps of:
providing a personal banking account managed by at least one external server, wherein the personal banking account is associated with the user account;
prompting the user account to enter a transfer amount for the personal banking account with the user account;
relaying a transfer request from the user PC device, through the remote server, and to the external server, if the transfer amount is entered by the user account; and
executing the transfer request for the transfer amount between the personal banking account and the user account with the remote server, if a confirmation for the transfer request is received from the external server with the remote server.

17. The method of managing a personal payment platform, the method as claimed in claim 1 comprises the steps of:
prompting the user account to freeze the virtual credit cards for a specified amount of time with the user PC device;
relaying the specified amount of time from the user PC device to the remote server, if the virtual credit cards are selected to be frozen for the specified amount of time by the user account; and
preventing future transactions with the virtual credit cards with the remote server, until the specified amount of time is calculated to be elapsed by the remote server.

18. The method of managing a personal payment platform, the method as claimed in claim 1 comprises the steps of:
providing a linking widget integrated into at least one website hosted on at least one external server, wherein the linking widget is associated with the user account; and
receiving the payment request from the linking widget with the remote server during step (B).

19. The method of managing a personal payment platform, the method as claimed in claim 1 comprises the steps of:
providing the user account with user authentication information;
prompting to access the user account with the user PC device before step (B);
relaying a biometric reading from the user PC device to the remote server, if the user account is selected to be accessed by the user PC device;
comparing the biometric reading to the user authentication information with the remote server in order to verify the biometric reading with the user authentication information; and
granting the user PC device access to the user account with the remote server, if the biometric reading is verified with the user authentication information.

20. The method of managing a personal payment platform, the method as claimed in claim 1 comprises the steps of:
providing a plurality of store accounts managed by the remote server, wherein each store account includes at least one aisle inventory, and wherein the aisle inventory of each store account is associated with a corresponding aisle hub, and wherein the corresponding aisle hub is communicably coupled with the remote server;
tracking the aisle inventory of each store account with the corresponding aisle hub; and
receiving the payment request for at least one missing item entry with the remote server during step (B), if the missing item entry of the aisle inventory of an arbitrary store account is detected by the corresponding aisle hub, and if the missing item entry is associated as the user account, wherein the arbitrary store account is any account from the plurality of store accounts.

21. The method of managing a personal payment platform, the method as claimed in claim 20 comprises the steps of:
providing each store account with a geofenced location;
tracking a user location with the user PC device; and
outputting an advertising notification for a specific store account with the user PC device, if the user location is within the geofenced location of the specific store account.

22. The method of managing a personal payment platform, the method as claimed in claim 20 comprises the steps of:
providing the corresponding aisle hub with at least one scanner;
prompting the user account to buy the missing item entry with the scanner; and
generating the payment request for the missing item entry with the scanner, if the missing item entry is selected to be bought by the user account.

23. The method of managing a personal payment platform, the method as claimed in claim 22 comprises the steps of:
comparing the missing item entry to each item entry from the aisle inventory of the arbitrary store with the remote server in order to identify at least one contextually-related item entry from the aisle inventory of the arbitrary store; and
outputting an advertising notification for the contextually-related item entry with the user PC device.

24. The method of managing a personal payment platform, the method as claimed in claim 1 comprises the steps of:
providing a plurality of service-provider profiles managed by the remote server, wherein each service-provider profile includes a set of service qualifications and provide contact information;
prompting the user account to enter a service request with the user PC device;
relaying the service request from the user PC device to the remote server, if the service request is entered by the user account;
comparing the service request to the set of service qualifications for each service-provider profile with the remote server in order to identify at least one matching profile from the plurality of service-provider profiles;
relaying the service request from the remote server to the provider contact information of the matching profile; and
generating the payment request for the service request with the remote server during step (B), if a completion confirmation of the service request is received by the remote server.

25. The method of managing a personal payment platform, the method as claimed in claim 1 comprises the steps of:
providing a plurality of inventory entries managed by the remote server, wherein each inventory entry includes an item description, a store location, and a store price;
prompting the user account to enter at least one shopping list entry with the user PC device;
relaying the shopping list entry from the user PC device to the remote server, if the shopping list entry is entered by the user account;
comparing the shopping list entry to the item description of each inventory entry with the remote server in order to identify a plurality of matching entries from the plurality of inventory entries;
comparing the store price of each matching entry amongst each other with the remote server in order to identify at least one lower-priced entry from the plurality of matching entries; and
outputting an advertising notification for the lower-priced entry with the user PC device.

26. The method of managing a personal payment platform, the method as claimed in claim 1 comprises the steps of:
providing a plurality of inventory entries managed by the remote server, wherein each inventory entry includes an item description, a store location, and a store price;
tracking at least one repetitively-bought entry for the user account with the remote server;
comparing the repetitively-bought entry to the item description of each inventory entry with the remote server in order to identify a plurality of matching entries from the plurality of inventory entries;
comparing the store price of each matching entry amongst each other with the remote server in order to identify at least one lower-priced entry from the plurality of matching entries; and
outputting an advertising notification for the lower-priced entry with the user PC device.

27. The method of managing a personal payment platform, the method as claimed in claim 1 comprises the steps of:
(F) providing a plurality of inventory entries managed by the remote server, wherein each inventory entry includes an item description, a store location, a store price, and wherein each inventory entry is encoded with a purchasing identifier;
(G) receiving the purchasing identifier of an arbitrary entry with the remote server, wherein the arbitrary entry is any entry from the plurality of inventory entries; and
(H) executing a plurality of iterations for step (G) as the remote server tracks and updates the plurality of inventory entries based on the purchasing identifier of each iteration for step (G).

28. The method of managing a personal payment platform, the method as claimed in claim 1 comprises the steps of:
providing a vehicle computing device, wherein the vehicle computing device is associated with the user account, and wherein the vehicle computing device is electronically connected to at least one vehicle output device;
relaying a maintenance warning from the vehicle computing device, through the remote server, to the user PC device; and
outputting the maintenance warning with the user PC device and/or the vehicle output device.

29. The method of managing a personal payment platform, the method as claimed in claim 1, wherein the user PC device manages an automated personal assistant service.

30. The method of managing a personal payment platform, the method as claimed in claim 1 comprises the steps of:
providing the user account with at least one membership identification;
prompting the user account to access the membership identification with the user PC device;
outputting the membership identification with the user PC device, if the membership identification is selected to be accessed by the user account; and
generating the payment request for a renewal fee with the remote server during step (B), wherein the renewal fee is associated with the membership identification.

31. The method of managing a personal payment platform, the method as claimed in claim 1 comprises the steps of:
providing the user account with at least one event ticket;
prompting the user account to access the event ticket with the user PC device;
outputting the event ticket with the user PC device, if the event ticket is selected to be accessed by the user account; and
generating the payment request for the event ticket with the remote server during step (B).
